(19) United States
(12) Patent Application Publication
(10) Pub. No.: US 2016/0237288 A1
(43) Pub. Date: Aug. 18, 2016

(54) SHEET FOR SEALING AND METHOD FOR MANUFACTURING SEMICONDUCTOR DEVICE

(71) Applicant: NITTO DENKO CORPORATION, Ibaraki-shi, Osaka (JP)

(72) Inventors: Goji Shiga, Ibaraki-shi, Osaka (JP); Koji Mizuno, Ibaraki-shi, Osaka (JP)

(21) Appl. No.: 14/912,866

(22) PCT Filed: Jul. 18, 2014
(86) PCT No.: PCT/JP2014/069220

§ 371 Date: Feb. 18, 2016

(30) Foreign Application Priority Data
Aug. 21, 2013 (JP) 2013-171054

(51) Int. Cl. C09D 5/24

(52) U.S. Cl. CPC C09D 5/24

(57) ABSTRACT

Provided is a sheet for sealing in which a semiconductor chip is to be embedded, and a surface of the sheet has a surface specific resistance value of 1.0×10¹²Ω or less.

### TECHNICAL FIELD

The present invention relates to a sheet for sealing, and a method for manufacturing a semiconductor device using the sheet for sealing.

### BACKGROUND ART

As a method for manufacturing a semiconductor device, there has been known a method of sealing one or more semiconductor chips fixed to a substrate with a sealing resin, and then dicing the resultant sealed body into a package for a semiconductor device unit. As such a sealing resin, for example, a thermosetting resin sheet is known (see, for example, Patent Document 1).

### PRIOR ART DOCUMENT

### Patent Document

Patent Document 1: JP-A-2006-19714

### SUMMARY OF THE INVENTION

### Problem to be Solved by the Invention

Conventionally, however, when a thermosetting resin sheet is used to manufacture a semiconductor device, a circuit formed on its semiconductor chip may be broken.

### Means for Solving the Problem

The inventors have investigated about a cause of breakage of the circuit on the semiconductor chip. As a result, the inventors have found out that when a release sheet bonded to the thermosetting resin sheet is peeled, peel electrification is generated between the release sheet and the thermosetting resin sheet so that the circuit on the semiconductor chip is broken by the generated static electricity in some cases.

The inventors have investigated to solve the problem in the prior to find out that the circuit on the semiconductor chip can be restrained from being broken by setting the surface specific resistance value of a surface of the sheet for sealing within a predetermined range. Thus, the present invention has been achieved.

Accordingly, the sheet for sealing according to the present invention is a sheet for sealing in which a semiconductor chip is to be embedded, a surface of this sheet having a surface specific resistance value of 1.0×10¹²Ω or less.

According to this structure, the surface specific resistance value of the surface of the sheet for sealing is 1.0×10¹²Ω or less so that the sheet for sealing is not easily electrified. Accordingly, when a release sheet bonded to the sheet for sealing is peeled therefrom, the generation of peel electrification can be restrained between the release sheet and the sheet for sealing. As a result, the semiconductor chip is prevented from being broken by the peel electrification, so that a semiconductor device manufactured using the sheet for sealing can be improved in reliability.

In this structure, it is preferred that an antistatic agent is contained in the sheet for sealing. When the antistatic agent is contained in the sheet for sealing, the sheet for sealing has an antistatic effect even after the release sheet is peeled therefrom. As a result, the semiconductor chip can be restrained from being broken by electrification even after the chip-attached sheet for sealing is peeled from the release sheet.

The present invention is also a method for manufacturing a semiconductor device, including:

a step A of fixing a semiconductor chip onto a support, and

a step B of embedding the semiconductor chip fixed onto the support in a sheet for sealing to form a sealed body,

wherein a surface of the sheet for sealing has a surface specific resistance value of 1.0×10¹²Ω or less.

According to this method, the surface specific resistance value of the surface of the sheet for sealing is 1.0×10¹²Ω or less. Since the surface specific resistance value is 1.0×10¹²Ω or less, the sheet can exhibit an antistatic effect. As a result, the semiconductor chip is prevented from being broken by peel electrification generated when a release sheet bonded to the sheet for sealing is peeled therefrom. Thus, a semiconductor device manufactured using the sheet for sealing can be improved in reliability.

In the method, it is preferred that an antistatic agent is contained in the sheet for sealing. When the antistatic agent is contained in the sheet for sealing, the sheet for sealing has an antistatic effect even after the chip-attached sheet for sealing is peeled from the release sheet. As a result, the semiconductor chip can be restrained from being broken by electrification even after the chip-attached sheet for sealing is peeled from the release sheet.

### Effect of the Invention

The present invention can provide a sheet for sealing that makes it possible to prevent a semiconductor chip from being broken by peel electrification, and improve a manufactured semiconductor device in reliability, and a method for manufacturing a semiconductor device using this sheet for sealing.

### BRIEF DESCRIPTION OF THE DRAWINGS

FIG. 1 is a schematic sectional view referred to for describing a method according to a first embodiment of the present invention for manufacturing a semiconductor device.

FIG. 2 is a schematic sectional view referred to for describing the method according to the first embodiment of the invention for manufacturing the semiconductor device.

FIG. 3 is a schematic sectional view referred to for describing the method according to the first embodiment of the invention for manufacturing the semiconductor device.

FIG. 4 is a schematic sectional view referred to for describing the method according to the first embodiment of the invention for manufacturing the semiconductor device.

FIG. 5 is a schematic sectional view referred to for describing the method according to the first embodiment of the invention for manufacturing the semiconductor device.

FIG. 6 is a schematic sectional view referred to for describing the method according to the first embodiment of the invention for manufacturing the semiconductor device.

FIG. 7 is a schematic sectional view referred to for describing the method according to the first embodiment of the invention for manufacturing the semiconductor device.

FIG. 8 is a schematic sectional view referred to for describing the method according to the first embodiment of the invention for manufacturing the semiconductor device.

FIG. 9 is a schematic sectional view referred to for describing the method according to the first embodiment of the invention for manufacturing the semiconductor device.

FIG. 10 is a schematic sectional view referred to for describing the method according to the first embodiment of the invention for manufacturing the semiconductor device.

FIG. 11 is a schematic sectional view referred to for describing the method according to the first embodiment of the invention for manufacturing the semiconductor device.

FIG. 12 is a schematic structural view referred to for describing the method for measuring the peel electrification voltage.

FIG. 13 is a schematic sectional view referred to for describing the method according to a second embodiment of the invention for manufacturing the semiconductor device.

FIG. 14 is a schematic sectional view referred to for describing the method according to the second embodiment of the invention for manufacturing the semiconductor device.

FIG. 15 is a schematic sectional view referred to for describing the method according to the second embodiment of the invention for manufacturing the semiconductor device.

FIG. 16 is a schematic sectional view referred to for describing the method according to the second embodiment of the invention for manufacturing the semiconductor device.

FIG. 17 is a schematic sectional view referred to for describing the method according to the second embodiment of the invention for manufacturing the semiconductor device.

FIG. 18 is a schematic sectional view referred to for describing the method according to the second embodiment of the invention for manufacturing the semiconductor device.

FIG. 19 is a schematic sectional view referred to for describing the method according to the second embodiment of the invention for manufacturing the semiconductor device.

FIG. 20 is a schematic sectional view referred to for describing the method according to the second embodiment of the invention for manufacturing the semiconductor device.

### MODE FOR CARRYING OUT THE INVENTION

Hereinafter, an embodiment of the present invention will be described, referring to the drawings. However, the invention is not limited only to the embodiment. In the embodiment described below, a description will be made about a case where an electronic device in the invention is a semiconductor chip.

### First Embodiment

A method for manufacturing a semiconductor device according to a first embodiment includes at least the following steps:

a step A of flip-chip bonding a semiconductor chip onto a circuit-forming surface of a semiconductor wafer, and

a step B of embedding the semiconductor chip flip-chip bonded onto the semiconductor wafer in a sheet for sealing to form a sealed body,

wherein a surface of the sheet for sealing has a surface specific resistance value of 1.0×10¹²Ω or less.

In other words, in the first embodiment, a description will be made about a case where the “support” in the present invention is a “semiconductor wafer.” The first embodiment is a method for manufacturing a semiconductor device of what is called a chip-on-wafer type.

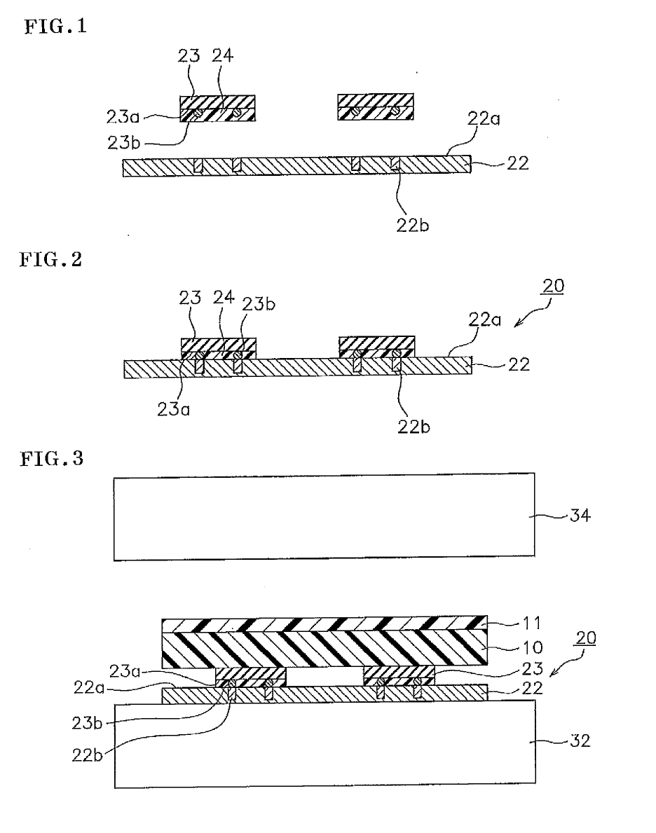

FIGS. 1 to 11 are each a schematic sectional view referred to for describing the semiconductor device manufacturing method according to the first embodiment of the present invention.

### [Providing Step]

As illustrated in FIG. 1, in the semiconductor device manufacturing method according to the first present embodiment, provided are initially one or more semiconductor chips 23 each having a circuit-forming surface 23a, and a semiconductor wafer 22 having a circuit-forming surface 22a. Hereinafter, a description will be made about a case where the plural semiconductor chips are flip-chip bonded to the semiconductor wafer.

### [Step of Flip-Chip Bonding Semiconductor Chips]

Next, as illustrated in FIG. 2, the semiconductor chips 23 are flip-chip bonded to the circuit-forming surface 22a of the semiconductor wafer 22 (step A). For the mounting of the semiconductor chips 23 onto the semiconductor wafer 22, a known apparatus is usable, which is, for example, a flip-chip bonder or a die bonder. Specifically, bumps 23b formed in the circuit-forming surface 23a of each of the semiconductor chips 23 are electrically connected to electrodes 22b formed in the circuit-forming surface 22a of the semiconductor wafer 22. This manner makes it possible to yield a stacked body 20 in which the semiconductor chips 23 are mounted on the semiconductor wafer 22. At this time, a resin sheet 24 for underfill may be bonded to the circuit-forming surface 23a of each of the semiconductor chips 23. In this case, by flip-chip bonding the semiconductor chips 23 onto c, gaps between the semiconductor chips 23 and the semiconductor wafer 22 can be sealed up with the resin. A method for flip-chip bonding the semiconductor chips 23, to which the resin sheets 24 for underfill are bonded, onto the semiconductor wafer 22 is disclosed in, for example, JP-A-2013-115186; thus, detailed description thereabout is omitted herein.

### [Step of Providing Sheet for Sealing]

As illustrated in FIG. 3, in the method for manufacturing a semiconductor device according to the present embodiment, a sheet 10 for sealing is provided. The sheet 10 for sealing is provided usually in the state of being stacked onto a release liner 11 such as a polyethylene terephthalate (PET) film. In this case, the release liner 11 may be subjected to release treatment for attaining the peeling of the sheet 10 for sealing easily.

### (Sheet for Sealing)

About the sheet 10 for sealing, the surface specific resistance value of a surface thereof is 1.0×10¹²Ω or less, preferably 1.0×10¹¹Ω or less, more preferably 1.0×10¹⁰Ω or less. When the sheet 10 for sealing has a multilayered structure and one of the outermost layers thereof contains an antistatic agent, the surface specific resistance value of the outer surface of the outermost layer containing the antistatic agent is preferably 1.0×10¹²Ω or less, more preferably 1.0×10¹¹Ω or less, even more preferably 1.0×10¹⁰Ω or less. As the surface specific resistance value is smaller, a more preferred result is obtained. The surface specific resistance value may be, for example, 1.0×10⁵Ω or more, 1.0×10⁶Ω or more, or 1.0×10⁷Ω or more. Since the surface specific resistance value is 1.0×10¹²Ω or less, the sheet for sealing is not easily electrified. Accordingly, the sheet can further exhibit an antistatic effect. The surface specific resistance value is a value measured by a method in the item “EXAMPLES.”

In the release liner 11-attached sheet 10 for sealing, the peel strength between the release liner 11 and the sheet 10 for sealing is preferably from 0.01 to 0.5 N/20 mm, more preferably from 0.02 to 0.4 N/20 mm according to a peeling test at a peeling angle of 90° and a tension rate of 300 mm/min. When the peel strength is 0.01 N/20 mm or more, at the time of feeding the sheet for sealing while the release sheet 11-surface side of the sheet for sealing is adsorbed by, for example, an adsorbing collet, the sheet for sealing can be fed without a peel of the release sheet or a raise thereof. The matter that the peel strength is 0.5 N/20 mm or less makes it possible to peel the release sheet easily after the sealing of the semiconductor chips or the thermal curing of the sheet.

When the release liner 11 and the sheet 10 for sealing are peeled from each other in the release liner 11-attached sheet 10 for sealing at a peeling angle of 180° and a peel rate of 10 m/min, the absolute value of the peel electrification voltage is preferably 0.5 kV or less (from −0.5 kV to +0.5 kV), more preferably 0.3 kV or less (from −0.3 kV to +0.3 kV), even more preferably 0.2 kV or less (from −0.2 kV to +0.2 kV). When the absolute value of the peel electrification voltage is 0.5 kV or less, the sheet for sealing can further exhibit an antistatic effect.

Herein, a description is made about a method for measuring the peel electrification voltage.

FIG. 12 a schematic structural view referred to for describing the method for measuring the peel electrification voltage. First, a sheet 10 for sealing is provided in which onto each surface thereof is bonded a release liner 11. Next, the sheet for sealing from which the release liner 11 on the sheet surface opposite to a measuring surface of the sheet has been peeled is bonded to an acrylic plate 100 (thickness: 1 mm, width: 70 mm, and length: 100 mm) destaticized in advance. The bonding is attained to face the acrylic plate 100 and the release liner 11-removed surface of the sheet 10 for sealing to each other with a double-sided tape interposed therebetween using a hand roller. In this state, this sample is allowed to stand still in an environment of 23° C. temperature and 50% relative humidity for one day. Next, the acrylic plate 100 to which the sheet 10 for sealing is bonded is fixed onto a sample fixing stand 102. Next, an end of the release liner 11 is fixed onto an automatic winding machine, and then the release liner 11 is peeled at a peeling angle of 180° and a peel rate of 10 m/min. At this time, the generated potential of the release sheet-side surface of the sample is measured using a potential meter 104 (KSD-0103, manufactured by Kasuga Electric Works Ltd.) fixed at a position 100 mm apart from the surface of the sheet 10 for sealing. The measurement is made in an environment of 23° C. temperature and 50% relative humidity.

The sheet 10 for sealing preferably contains an antistatic agent. When the sheet 10 for sealing contains the antistatic agent, the sheet 10 has an antistatic effect even after peeled from the release sheet 11. As a result, even after the sheet 10 for sealing is peeled from the release sheet 11, the semiconductor chips can be restrained from being broken by electrification. In particular, when the sheet 10 for sealing has a multilayered structure and further an antistatic agent is contained in the release sheet 11-side outermost layer of the multilayered sheet 10 for sealing, peel electrification can be more effectively restrained when the release sheet 11 and the sheet 10 for sealing are peeled from each other.

The release sheet 11 may contain an antistatic agent.

Examples of the antistatic agent include cationic antistatic agents having a cationic functional group such as a quaternary ammonium salt, a pyridinium salt, a primary, a secondary, and a tertiary amino group; anionic antistatic agents having an anionic functional group such as sulfonate, sulfate, phosphonate, and phosphate; amphoteric antistatic agents such as alkylbetaine and its derivatives, imidazoline and its derivatives, and alanine and its derivatives; nonionic antistatic agents such as aminoalcohol and its derivatives, glycerin and its derivatives, and polyethylene glycol and its derivatives; and ionically conductive polymers (polymeric antistatic agents) obtained by polymerizing or copolymerizing monomers having the above-described cationic, anionic, and amphoteric ionically conductive groups. These compounds may be used alone or in combination of two or more kinds thereof. Among these, a polymeric antistatic agent is preferable. When a polymeric antistatic agent is used, bleeding of the agent from the sheet 10 for sealing and the release sheet 11 less likely occurs. As a result, a decrease in antistatic function over time can be suppressed.

Specific examples of the cationic antistatic agent include (meth)acrylate copolymers having a quaternary ammonium group such as an alkyltrimethyl ammonium salt, acyloylamidopropyltrimethyl ammonium methosulfate, an alkylbenzylmethyl ammonium salt, choline acyl chloride, and polydimethylaminoethyl methacrylate; styrene copolymers having a quaternary ammonium group such as polyvinylbenzyltrimethyl ammonium chloride; and diallylamine copolymers having a quaternary ammonium group such as polydiallyldimethyl ammonium chloride. These compounds may be used alone or in combination of two or more kinds thereof.

Examples of the anionic antistatic agent include alkyl sulfonate, alkylbenzene sulfonate, alkylsulfate, alkylethoxysulfate, alkyl phosphate, and a sulfonic acid group-containing styrene copolymer. These compounds may be used alone or in combination of two or more kinds thereof.

Examples of the amphoteric antistatic agent include alkylbetaine, alkylimidazoliumbetaine, and a carbobetaine graft copolymer. These compounds may be used alone or in combination of two or more kinds thereof.

Examples of the nonionic antistatic agent include fatty acid alkylolamide, di(2-hydroxyethyl)alkylamine, polyoxyethylene alkylamine, fatty acid glycerol ester, polyoxyethylene glycol fatty acid ester, sorbitan fatty acid ester, polyoxysorbitan fatty acid ester, polyoxyethylene alkylphenylether, polyoxyethylene alkylether, polyethylene glycol, polyoxyethylene diamine, a copolymer including polyether, polyester, and polyamide, methoxypolyethylene glycol (meth)acrylate, and the like. These compounds may be used alone or in combination of two or more kinds thereof.

Other examples of the polymeric antistatic agent include polyaniline, polypyrrole, polythiophene, and the like.

Other examples of the antistatic agent include conductive substances. Examples of the conductive substance include tin oxide, antimony oxide, indium oxide, cadmium oxide, titanium oxide, zinc oxide, indium, tin, antimony, gold, silver, copper, aluminum, nickel, chromium, titanium, iron, cobalt, copper iodide, and alloys and mixtures thereof.

The content of the antistatic agent is preferably 50% by weight or less and more preferably 30% by weight or less to the entire resin component of the layer where the antistatic agent is added. The content of the antistatic agent is preferably 5% by weight or more and more preferably 10% by weight or more to the entire resin component of the layer where the antistatic agent is added. When the antistatic agent is contained within the above-described range, the antistatic function can be given without interfering with the functions of the layer where the antistatic agent in added. Here, “50% by weight or less to the entire resin component of the layer where the antistatic agent is added” means as follows.

(a) When the layer where the antistatic agent is added is the sheet 10 for sealing

When the sheet 10 for sealing is composed of one layer, it means 50% by weight or less to the entire resin component that constitutes the sheet 10 for sealing.

When the sheet 10 for sealing is constituted with a multilayered structure, it means 50% by weight or less to the entire resin component that constitutes one of the multiple layers.

(b) When the layer where the antistatic agent is added is the release sheet 11

It means 50% by weight or less to the entire resin component that constitutes the release sheet 11.

The sheet 10 for sealing preferably contains an epoxy resin, and a phenolic resin as a curing agent. According to this case, the sheet 10 can gain a good thermosetting property.

The epoxy resin is not especially limited. For example, various kinds of epoxy resins can be used such as a triphenylmethane-type epoxy resin, a cresol novolac-type epoxy resin, a biphenyl-type epoxy resin, a modified bisphenol A-type epoxy resin, a bisphenol A-type epoxy resin, a bisphenol F-type epoxy resin, a modified bisphenol F-type epoxy resin, a dicyclopentadiene-type epoxy resin, a phenol novolac-type epoxy resin, and a phenoxy resin. These epoxy resins may be used alone or in combination of two or more thereof.

From the viewpoint of securing the toughness of the epoxy resin after curing and the reactivity of the epoxy resin, epoxy resins are preferable which are solid at normal temperature and have an epoxy equivalent of 150 to 200 and a softening point or melting point of 50 to 130° C. Among these epoxy resins, a triphenylmethane-type epoxy resin, a cresol novolac-type epoxy resin, and a biphenyl-type epoxy resin are more preferable from the viewpoint of reliability.

The phenol resin is not especially limited as long as it initiates curing reaction with the epoxy resin. For example, there can be used a phenol novolac resin, a phenolaralkyl resin, a biphenylaralkyl resin, a dicyclopentadiene-type phenol resin, a cresol novolac resin, a resol resin, etc. These phenol resins may be used alone or in combination of two or more thereof.

From the viewpoint of the reactivity with the epoxy resin, phenol resins are preferably used which have a hydroxy group equivalent of 70 to 250 and a softening point of 50 to 110° C. Among these phenol resins, a phenol novolac resin is more preferably used from the viewpoint of its high curing reactivity. Further, phenol resins having low moisture absorbability can be also preferably used such as a phenolaralkyl resin and a bisphenylaralkyl resin from the viewpoint of reliability.

For the compounding ratio of the phenol resin to the epoxy resin, the epoxy resin and the phenol resin are preferably compounded so that the total amount of the hydroxy group in the phenol resin is 0.7 to 1.5 equivalents, and more preferably 0.9 to 1.2 equivalents, to 1 equivalent of the epoxy group in the epoxy resin.

The total content of the epoxy resin and the phenol resin in the sheet 10 for sealing is preferably 2.5% by weight or more, and more preferably 3.0% by weight or more. If the content is 2.5% by weight or more, good adhering strength to the semiconductor chips 23 and the semiconductor wafer 22 can be obtained. The total content of the epoxy resin and the phenol resin in the sheet 10 for sealing is preferably 20% by weight or less, and more preferably 10% by weight or less. If the content is 20% by weight or less, moisture absorbability can be decreased.

The sheet 10 for sealing preferably contains a thermoplastic resin. This makes it possible to provide a handling property when the sheet 10 for sealing is uncured and low stress property to the cured product.

Examples of the thermoplastic resin include natural rubber, butyl rubber, isoprene rubber, chloroprene rubber, an ethylene-vinylacetate copolymer, an ethylene-acrylic acid copolymer, an ethylene-acrylate copolymer, a polybutadiene resin, a polycarbonate resin, a thermoplastic polyimide resin, polyamide resins such as 6-nylon and 6,6-nylon, a phenoxy resin, an acrylic resin, saturated polyester resins such as PET and PBT, a polyamideimide resin, a fluororesin, and a styrene-isobutylene-styrene block copolymer. These thermoplastic resins may be used alone or in combination of two or more thereof. Among these, a styrene-isobutylene-styrene block copolymer is preferable from the viewpoint of its low stress property and low moisture absorption.

The content of the thermoplastic resin in the sheet 10 for sealing is preferably 1.5% by weight or more, and more preferably 2.0% by weight. If the content is 1.5% by weight or more, the flexibility can be obtained. The content of the thermoplastic resin in the sheet 10 for sealing is preferably 6% by weight or less, and more preferably 4% by weight or less. If the content is 4% by weight or less, the adhesion with the semiconductor chips 23 and the semiconductor wafer 22 is good.

The sheet 10 for sealing preferably contains an inorganic filler.

The inorganic filler is not especially limited, and various kinds of conventionally known fillers can be used. Examples thereof include powers of quartz glass, talc, silica (such as fused silica and crystalline silica), alumina, aluminum nitride, silicon nitride, and boron nitride. These may be used alone or in combination of two or more kinds. Among these, silica and alumina are preferable, and silica is more preferable due to the reason that the linear expansion coefficient can be satisfactorily decreased.

As silica, silica powers are preferable, and fused silica powers are more preferable. Examples of the fused silica powders include spherical fused silica powders and crushed and fused silica powders. However, spherical fused silica powders are preferable from the viewpoint of fluidity. Among these, powers having an average particle size of 10 to 30 μm are preferable, and powders having an average particle size of 15 to 25 μm are more preferable.

The average particle size can be obtained, for example, by measurement on a sample that is extracted arbitrarily from the population using a laser diffraction-scattering type particle size distribution measuring apparatus. Of these powders, a powder having an average particle diameter of 10 to 30 μm is preferred, and one having an average particle diameter of 15 to 25 μm is more preferred.

The average particle diameter can be gained, for example, by using a sample extracted arbitrarily from a population of the powder, and measuring the sample using a laser diffraction scattering particle size distribution measuring instrument.

The content of the inorganic filler in the sheet 10 for sealing is preferably from 75 to 95% by weight, more preferably from 78 to 95% by weight of the whole of the sheet 10 for sealing. When the content of the inorganic filler is 75% by weight or more of the whole of the sheet 10 for sealing, this sheet can be controlled low in thermal expansion coefficient to be restrained from being mechanically broken by thermal impact. In the meantime, when the content of the inorganic filler is 95% by weight or less of the whole of the sheet 10 for sealing, the sheet for sealing becomes better in softness, fluidity and adhesion.

The sheet 10 for sealing preferably contains a curing accelerator.

The curing accelerator is not especially limited as long as it promotes curing of the epoxy resin and the phenol resin, and examples of the curing accelerator include organophosphate compounds such as triphenylphosphine and tetraphenylphosphonium tetraphenylborate; and imidazole compounds such as 2-phenyl-4,5-dihydroxymethylimidazole and 2-phenyl-4-methyl-5-hydroxymethylimidazole. Among these, 2-phenyl-4,5-dihydroxymethylimidazole is preferable due to the reason that the curing reaction does not rapidly proceed even when the temperature increases during kneading and the sheet 10 for sealing can be produced satisfactorily.

The content of the curing accelerator is preferably 0.1 to 5 parts by weight to the total 100 parts by weight of the epoxy resin and the phenol resin.

The sheet 10 for sealing preferably contains a flame retardant component. This makes it possible to reduce an expansion of combustion when the sheet 10 for sealing catches fire due to short circuit of the parts or heat generation. Examples of the flame retardant component include various kinds of metal hydroxides such as aluminum hydroxide, magnesium hydroxide, iron hydroxide, calcium hydroxide, tin hydroxide, and composite metal hydroxide; and a phosphazene flame retardant.

From the viewpoint of exhibiting flame retardancy even with a small amount, the content of phosphorus element in the phosphazene flame retardant is preferably 12% by weight or more.

The content of the flame retardant component in the sheet 10 for sealing is preferably 10% by weight or more, and more preferably 15% by weight or more in the entire organic component (excluding inorganic filler). If the content is 10% by weight or more, the flame retardancy can be obtained satisfactorily. The content of the thermoplastic resin in the sheet 10 for sealing is preferably 30% by weight or less, and more preferably 25% by weight or less. If the content is 30% by weight or less, deterioration in the physical properties (deterioration in physical properties such as glass transition temperature and resin strength at high temperature) of the cured product tends to be suppressed.

The sheet 10 for sealing preferably contains a silane coupling agent. The silane coupling agent is not especially limited, and an example includes 3-glycidoxypropyl trimethoxysilane.

The content of the silane coupling agent in the sheet 10 for sealing is preferably 0.1 to 3% by weight. If the content is 0.1% by weight or more, the strength of the cured product is sufficiently made high, so that the water absorption can be lowered. If the content is 3% by weight or less, the amount of outgas can be decreased.

The sheet 10 for sealing is preferably colored. With this configuration, The sheet 10 for sealing can exhibit an excellent marking property and an excellent appearance, and a semiconductor device can be obtained having an appearance with added value. Because the colored sheet 10 for sealing has an excellent marking property, various information such as character information and pattern information can be given by marking. Especially, the information such as character information and pattern information that is given by marking can be recognized visually with excellent visibility by controlling the color. It is possible to color-code the sheet 10 for sealing by product, for example. When the sheet 10 for sealing is colored (when it is not colorless or transparent), the color is not especially limited. However, the color is preferably a dark color such as black, blue, or red, and black is especially preferable.

In this embodiment, the dark color means a dark color having L* that is defined in the L*a*b* color system of basically 60 or less (0 to 60), preferably 50 or less (0 to 50) and more preferably 40 or less (0 to 40).

The black color means a blackish color having L* that is defined in the L*a*b* color system of basically 35 or less (0 to 35), preferably 30 or less (0 to 30) and more preferably 25 or less (0 to 25). In the black color, each of a* and b* that is defined in the L*a*b* color system can be appropriately selected according to the value of L*. For example, both of a* and b* are preferably −10 to 10, more preferably −5 to 5, and especially preferably −3 to 3 (above all, 0 or almost 0).

In this embodiment, L*, a*, and b* that are defined in the L*a*b* color system can be obtained by measurement using a colorimeter (tradename: CR-200 manufactured by Konica Minolta Holdings, Inc.). The L*a*b* color system is a color space that is endorsed by Commission Internationale de I'Eclairage (CIE) in 1976, and means a color space that is called a CIE1976 (L*a*b*) color system. The L*a*b* color system is provided in JIS Z 8729 in the Japanese Industrial Standards.

When the sheet 10 for sealing is colored, a coloring material (colorant) is usable in accordance with a target color. The sheet of the present invention for sealing may be made of a single layer or made of plural layers. It is preferred that the colorant is added at least to the side of the sheet surface opposite to the sheet surface that faces the semiconductor wafer. Specifically, when the sheet for sealing is made of a single layer, the colorant may be evenly contained in the whole of the sheet for sealing, or may be contained to be unevenly distributed in the side of the sheet surface opposite to the sheet surface that faces the semiconductor wafer. When the sheet for sealing is made of plural layers, it is permissible to add the colorant to a layer at the side of the sheet surface opposite to the sheet surface that faces the semiconductor wafer 22, and further not to add the colorant to the other layer(s). In the present embodiment, a description is made about a case where the sheet of the present invention for sealing is the sheet 10 for sealing that is a monolayered-structure sheet. About a case where the sheet for sealing has two or more layers, a description will be later made with reference to FIG. 12. When the colorant is added to the side of the sheet surface opposite to the sheet surface that faces the semiconductor wafer in the sheet for sealing, a region of the sheet which has been laser-marked can be improved in visibility. Various dark color materials such as black color materials, blue color materials, and red color materials can be suitably used, and especially the black color materials are suitable. The color materials may be any of pigments, dyes, and the like. The color materials can be used alone or two types or more can be used together. Any dyes such as acid dyes, reactive dyes, direct dyes, dispersive dyes, and cationic dyes can be used. The pigments are also not especially limited in the form, and may be appropriately selected from known pigments.

The use of, in particular, the dye as the coloring material puts the sheet 10 for sealing into a state that the dye is evenly or substantially evenly dissolved or dispersed in the sheet 10, so that the sheet 10 for sealing can easily be produced with an even or substantially even color density to be improved in markability and external appearance.

The black color material is not especially limited, and can be appropriately selected from inorganic black pigments and black dyes, for example. The black color material may be a color material mixture in which a cyan color material (blue-green color material), a magenta color material (red-purple color material), and a yellow color material are mixed together. The black color materials can be used alone or two types or more can be used together. The black color materials can be used also with other color materials other than black.

Specific examples of the black color materials include carbon black such as furnace black, channel black, acetylene black, thermal black, and lamp black, graphite (black lead), copper oxide, manganese dioxide, azo pigments such as azomethine azo black, aniline black, perylene black, titanium black, cyanine black, activated carbon, ferrite such as nonmagnetic ferrite and magnetic ferrite, magnetite, chromium oxide, iron oxide, molybdenum disulfide, chromium complex, complex oxide black, and anthraquinone organic black.

In the present invention, black dyes such as C. I. solvent black 3, 7, 22, 27, 29, 34, 43, and 70, C. I. direct black 17, 19, 22, 32, 38, 51, and 71, C. I. acid black 1, 2, 24, 26, 31, 48, 52, 107, 109, 110, 119, and 154, and C. I. disperse black 1, 3, 10, and 24; and black pigments such as C. I. pigment black 1 and 7 can be used as the black color material.

Examples of such black color materials that are available on the market include Oil Black BY, Oil Black BS, Oil Black HBB, Oil Black 803, Oil Black 860, Oil Black 5970, Oil Black 5906, and Oil Black 5905 manufactured by Orient Chemical Industries Co., Ltd.

Examples of color materials other than the black color materials include a cyan color material, a magenta color material, and a yellow color material. Examples of the cyan color material include cyan dyes such as C. I. solvent blue 25, 36, 60, 70, 93, and 95; and C. I. acid blue 6 and 45; and cyan pigments such as C. I. pigment blue 1, 2, 3, 15, 15:1, 15:2, 15:3, 15:4, 15:5, 15:6, 16, 17, 17:1, 18, 22, 25, 56, 60, 63, 65, and 66; C. I. vat blue 4 and 60; and C. I. pigment green 7.

Examples of the magenta color material include magenta dyes such as C. I. solvent red 1, 3, 8, 23, 24, 25, 27, 30, 49, 52, 58, 63, 81, 82, 83, 84, 100, 109, 111, 121, and 122; C. I. disperse red 9; C. I. solvent violet 8, 13, 14, 21, and 27; C. I. disperse violet 1; C. I. basic red 1, 2, 9, 12, 13, 14, 15, 17, 18, 22, 23, 24, 27, 29, 32, 34, 35, 36, 37, 38, 39, and 40; and C. I. basic violet 1, 3, 7, 10, 14, 15, 21, 25, 26, 27, and 28.

Examples of the magenta color material include magenta pigments such as C. I. pigment red 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 42, 48:1, 48:2, 48:3, 48:4, 49, 49:1, 50, 51, 52, 52:2, 53:1, 54, 55, 56, 57:1, 58, 60, 60:1, 63, 63:1, 63:2, 64, 64:1, 67, 68, 81, 83, 87, 88, 89, 90, 92, 101, 104, 105, 106, 108, 112, 114, 122, 123, 139, 144, 146, 147, 149, 150, 151, 163, 166, 168, 170, 171, 172, 175, 176, 177, 178, 179, 184, 185, 187, 190, 193, 202, 206, 207, 209, 219, 222, 224, 238, and 245; C. I. pigment violet 3, 9, 19, 23, 31, 32, 33, 36, 38, 43, and 50; and C. I. vat red 1, 2, 10, 13, 15, 23, 29, and 35.

Examples of the yellow color material include yellow dyes such as C. I. solvent yellow 19, 44, 77, 79, 81, 82, 93, 98, 103, 104, 112, and 162; and yellow pigments such as C. I. pigment orange 31 and 43, C. I. pigment yellow 1, 2, 3, 4, 5, 6, 7, 10, 11, 12, 13, 14, 15, 16, 17, 23, 24, 34, 35, 37, 42, 53, 55, 65, 73, 74, 75, 81, 83, 93, 94, 95, 97, 98, 100, 101, 104, 108, 109, 110, 113, 114, 116, 117, 120, 128, 129, 133, 138, 139, 147, 150, 151, 153, 154, 155, 156, 167, 172, 173, 180, 185, and 195, and C. I. vat yellow 1, 3, and 20.

Various color materials such as cyan color materials, magenta color materials, and yellow color materials can be used alone or two types or more can be used together. When two types or more of various color materials such as cyan color materials, magenta color materials, and yellow color materials are used, the mixing ratio or the compounding ratio of these color materials is not especially limited, and can be appropriately selected according to the types of each color material and the intended color.

The light transmittance of the sheet 10 for sealing to visible rays (wavelength: 380 to 800 nm) (visible light transmittance) is not particularly limited, and ranges, for example, preferably from 20 to 0%, more preferably from 10 to 0%, in particular preferably from 5 to 0%. When the visible light transmittance of the sheet 10 for sealing is set to 20% or less, the sheet can be made good in printed-image visibility. Moreover, a bad effect of the passage of rays onto the semiconductor elements can be prevented.

About the visible light transmittance (%) of the sheet 10 for sealing, the sheet 10 for sealing is produced with a thickness (average thickness) of 10 μm, and a product with a trade name “UV-2550” (manufactured by Shimadzu Corporation) is used to radiate visible rays having wavelengths of 380 to 800 nm at a predetermined intensity onto the sheet 10 (thickness: 10 μm) for sealing. The light intensity of the visible rays transmitted through the sheet 10 for sealing by this radiation is measured, and then the visible light transmittance is calculated in accordance with the following expression.

Visible light transmittance (%)=(“light intensity of visible rays transmitted through sheet 10 for sealing”/“initial light intensity of visible rays”×100

This method for calculating the light transmittance (%) is applicable to the light transmittance (%) of the sheet 10 for sealing when the sheet has any thickness other than 10 μm. Specifically, in accordance with Lambert-Beer's law, the absorbance A₁₀ thereof when the thickness is 10 μm can be calculated as follows:

A₁₀=α×L₁₀×C (1)

wherein L₁₀ represents the light path length; α, the absorption coefficient; and C, the concentration of the sample.

The absorbance A_{X} of the sample when the thickness thereof is X (μm) can be represented by the following expression (2).

A_{X}=α×L_{X}×C (2)

The absorbance A₂₀ when the thickness is 20 (μm) can be represented by the following expression (3):

A₁₀=−log₁₀T₁₀ (3)

wherein T₁₀ represents the light transmittance when the thickness is 10 μm.

In accordance with the expressions (1) to (3), the absorbance A_{X} can be represented by the following.

$$\begin{matrix}{A}_{x} = {A}_{10} \times ( {L}_{x} / {L}_{10} ) \\ = - [ {log}_{10} ( {T}_{10} ) ] \times ( {L}_{x} / {L}_{10} )\end{matrix}$$

Using this absorbance, the light transmittance T_{X} (%) when the thickness is X (μm) can be calculated in accordance with the following:

T_{X}=10^{-AX}

wherein A_{X}=−[log₁₀(T₁₀)]×(L_{X}/L₁₀).

In the present embodiment, the thickness (average thickness) of the sheet for sealing is 10 μm when the light transmittance (%) of the sheet for sealing is gained. However, this thickness of the sheet for sealing is merely a thickness used when the light transmittance (%) of the sheet for sealing is gained. Thus, it is not meant that the thickness of the sheet for sealing is 10 μm in the present invention.

The light transmittance (%) of the sheet 10 for sealing is controllable in accordance with the kind and the content of the resin component, those of the colorant (such as the pigment or dye), those of the filler, and others.

Besides the above-mentioned individual components, any other additive may be appropriately blended into the sheet 10 for sealing, as required.

The thickness of the sheet 10 for sealing is not especially limited; however, it is for example 50 μm to 2,000 μm from the viewpoint of using the sheet as a sheet for sealing.

The method of manufacturing the sheet 10 for sealing is not especially limited; however, preferred examples are a method of preparing a kneaded product of the resin composition for forming the sheet 10 for sealing and applying the obtained kneaded product and a method of subjecting the obtained kneaded product to plastic-working to be formed into a sheet shape. This makes it possible to produce the sheet 10 for sealing without using a solvent. Therefore, the effects on the semiconductor chip 23 from the volatilized solvent can be suppressed.

Specifically, each component described later is melted and kneaded with a known kneader such as a mixing roll, a pressure kneader, or an extruder to prepare a kneaded product, and the obtained kneaded product is applied or plastic-worked into a sheet shape. As a kneading condition, the temperature is preferably the softening point or higher of each component described above, and is for example 30 to 150° C. When the thermal curing property of the epoxy resin is considered, the temperature is preferably 40 to 140° C., and more preferably 60 to 120° C. The time is for example 1 to 30 minutes, and preferably 5 to 15 minutes.

The kneading is preferably performed under a reduced pressure condition (under reduced pressure atmosphere). This makes it possible to remove gas, and to prevent invasion of gas into the kneaded product. The pressure under the reduced pressure condition is preferably 0.1 kg/cm² or less, and more preferably 0.05 kg/cm² or less. The lower limit of the pressure under reduced pressure is not especially limited; however, it is 1×10⁴ kg/cm² or more.

When the kneaded product is applied to form the sheet 10 for sealing, the kneaded product after being melt-kneaded is preferably applied while it is at high temperature without being cooled. The application method is not especially limited, and examples thereof include bar coating, knife coating, and slot-die coating. The application temperature is preferably the softening point or higher of each component described above. When the thermal curing property and molding property of the epoxy resin are considered, the temperature is for example 40 to 150° C., preferably 50 to 140° C., and more preferably 70 to 120° C.

When forming the sheet 10 for sealing by plastic-working the kneaded product, the kneaded product after melt-kneaded is preferably subjected to plastic-working while it is at high temperature without being cooled. The plastic-working process is not especially limited, and examples thereof include flat plate pressing, T-die extrusion, screw-die extrusion, rolling, roll kneading, inflation extrusion, coextrusion, and calendar molding. The temperature for plastic-working is preferably the softening point or higher of each component described above. When the thermal curing property and molding property of the epoxy resin are considered, the temperature is for example 40 to 150° C., preferably 50 to 140° C., and more preferably 70 to 120° C.

The sheet 10 for sealing may be obtained by dissolving or dispersing the resin and others for forming the sheet 10 for sealing in an appropriate solvent to prepare a varnish, and applying this varnish.

### [Step of Arranging Sheet for Sealing and Laminate]

After the step of providing the sheet for sealing, as shown in FIG. 3, the laminate 20 is arranged on a lower heating plate 32 with a surface on which the semiconductor chips 23 are mounted facing upward and the sheet 10 for sealing is arranged on a surface of the laminate 20 where the semiconductor chips 23 are mounted. In this step, the laminate 20 may be first arranged on the lower heating plate 32, and after that, the sheet 10 for sealing may be arranged on the laminate 20, or the sheet 10 for sealing may be first laminated on the laminate 20, and after that, this laminated product in which the laminate 20 and the sheet 10 for sealing are laminated may be arranged on the lower heating plate 32.

### [Step of Forming Sealed Body]

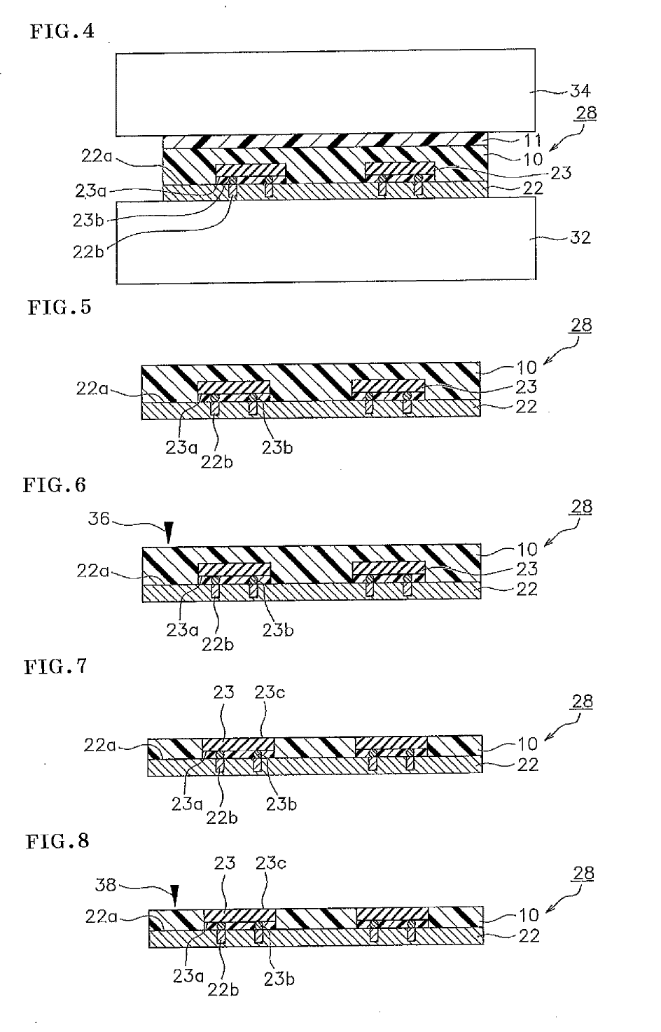

Next, as shown in FIG. 4, hot press is performed with the lower heating plate 32 and an upper heating plate 34 to embed the semiconductor chip 23 into the sheet 10 for sealing (step B). The sheet 10 for sealing functions as a sealing resin for protecting the semiconductor chip 23 and the elements attached to the chip from the external environment. This provides a sealed body 28 in which the semiconductor chip 23 that is mounted on the semiconductor wafer 22 is embedded into the sheet 10 for sealing.

For the hot pressing condition when the semiconductor chip 23 is embedded into the sheet 10 for sealing, the temperature is for example 40 to 100° C., and preferably 50 to 90° C.; the pressure is for example 0.1 to 10 MPa, and preferably 0.5 to 0.8 MPa; and the duration is for example 0.3 to 10 minutes, and preferably 0.5 to 5 minutes. This makes it possible to provide a semiconductor device in which the semiconductor chip 23 is embedded in the sheet 10 for sealing. In consideration of improvement of the tackiness and followability of the sheet 10 for sealing to the semiconductor chip 23 and the semiconductor wafer 22, pressing is preferably performed under a reduced pressure condition.

For the reduced pressure condition, the pressure is for example 0.1 to 5 kPa, and preferably 0.1 to 100 Pa; and the reduced pressure maintaining time (time from start of reducing pressure to start of pressing) is for example 5 to 600 seconds, and preferably 10 to 300 seconds.

### [Release Liner Peeling Step]

Next, the release liner 11 is peeled (see FIG. 5). At this time, the sheet 10 for sealing is not easily electrified since the surface specific resistance value of the sheet 10 is 1.0×10¹²Ω or less. Accordingly, the sheet 10 for sealing can further exhibit an antistatic effect. As a result, the semiconductor chip 23 is prevented from being broken by the peel electrification so that a semiconductor device 29 (see FIG. 11) manufactured using the sheet 10 for sealing can be improved in reliability.

### [Thermal Curing Step]

Next, the sheet 10 for sealing is thermally cured. Specifically, for example, the whole of the sealed body 28 is heated, in which the semiconductor chips 23 mounted onto the semiconductor wafer 22 are embedded in the sheet 10 for sealing.

For a condition of the thermal curing treatment, the heating temperature is preferably 100° C. or higher, and more preferably 120° C. or higher. On the other hand, the upper limit of the heating temperature is preferably 200° C. or lower, and more preferably 180° C. or lower. The heating time is preferably 10 minutes or more, and more preferably 30 minutes or more. On the other hand, the upper limit of the heating time is preferably 180 minutes or less, and more preferably 120 minutes or less. A pressure may be applied as necessary. The pressure is preferably 0.1 MPa or more, and more preferably 0.5 MPa or more. On the other hand, the upper limit of the pressure is preferably 10 MPa or less, and more preferably 5 MPa or less.

### [Laser-Marking Step 1 (Laser-Marking Step Before Sheet for Sealing is Ground)]

Next, as illustrated in FIG. 6, a laser 36 for laser marking is used to mark the sheet 10 for sealing with the laser. Conditions for the laser marking are not particularly limited. It is preferred at this time to radiate a laser [wavelength: 532 nm] onto the sheet 10 for sealing at an intensity of 0.3 to 2.0 W. It is also preferred to attain the radiation to set the working depth (depth) to 2 μm or more. The upper limit of the working depth is not particularly limited, and may be selected from, for example, the range of 2 to 25 μm. The upper limit is preferably 3 μm or more (3 to 20 μm), more preferably 5 μm or more (5 to 15 μm). By setting the laser-marking conditions in these numerical ranges, the laser exhibits excellent laser-marking performance.

The laser workability of the sheet 10 for sealing is controllable in accordance with the kind and the content of the constituent resin component, those of the colorant, those of the crosslinking agent, those of the filler, and others.

In the Laser-Marking Step 1, one or more spots of the sheet 10 which are to be laser-marked are not particularly limited, and may be spots just above the semiconductor chips 23, or one or more spots above semiconductor-chip-23-not-arranged positions of the wafer (for example, an outer circumferential portion of the sheet 10 for sealing). Information marked by the laser marking may be character information, figure information or any other information capable of distinguishing the sealed body from any other sealed body, or may be character information, figure information or any other information capable of distinguishing the semiconductor devices from each other inside the single sealed body 28. This step makes it possible to cause the sheet 10 for sealing to have performance of mutual distinction between the sealed body 28 and any other sealed body, or performance of mutual distinction between the semiconductor chips 23 inside the sealed body 28 until the next step, that is, until a time when the sheet 10 for sealing will be ground.

### [Step of Grinding Sheet for Sealing]

Next, as illustrated in FIG. 7, the sheet 10 for sealing of the sealed body 28 is ground to expose respective rear surfaces 23c of the semiconductor chips 23 (step C). The method for grinding the sheet 10 for sealing is not particularly limited, and may be, for example, a grinding method using a grinding stone rotatable at a high velocity.

In the Laser-Marking Step 1, when the thickness of the sheet over which the sheet is ground in the step C is larger than the marking depth (working depth), the marking is lost. In the meantime, when the thickness of the sheet over which the sheet is ground in the step C is smaller than the marking depth (working depth), the marking remains.

[Laser-Marking Step 2 (Laser-Marking Step after Sheet for Sealing is Ground)]

Next, as illustrated in FIG. 8, a laser 38 for laser marking is used to mark the sheet 10 for sealing with the laser. Conditions for the laser marking are not particularly limited. It is preferred to radiate a laser [wavelength: 532 nm] as the laser onto the sheet 10 for sealing at an intensity of 0.3 to 2.0 W. It is also preferred at this time to attain the radiation to set the working depth (depth) to 2 μm or more. The upper limit of the working depth is not particularly limited, and may be selected from, for example, the range of 2 to 25 μm. The upper limit is preferably 3 μm or more (3 to 20 μm), more preferably 5 μm or more (5 to 15 μm). By setting the laser-marking conditions in these numerical ranges, the laser exhibits excellent laser-marking performance.

In the Laser-Marking Step 2, one or more spots of the sheet 10 which are to be laser-marked are not particularly limited, and may be one or more spots above semiconductor-chip-23-not-arranged positions of the wafer. Information marked by the laser marking may be character information, figure information or any other information capable of distinguishing the sealed body from any other sealed body, or may be character information, figure information or any other information capable of distinguishing the semiconductor devices from each other inside the single sealed body 28. This step makes it possible to cause the sheet 10 for sealing to have performance of making mutual distinction between the sealed body 28 and any other sealed body, or performance of making mutual distinction between the semiconductor devices after the sheet 10 for sealing is ground. Even when the Laser-Marking Step 1 is performed, in particular, the marking may be lost by the grinding in the step E. However, when the sheet 10 for sealing is laser-marked in the Laser-Marking Step 2, the sheet for sealing can be caused to have performance of making mutual distinction between the sealed body 28 and any other sealed body, or between the semiconductor devices even after the sheet 10 for sealing is ground. The information marked by the laser marking may be figure information (alignment mark) for position alignment that is usable in a dicing step that will be later described.

### [Step of Forming Interconnect Layer]

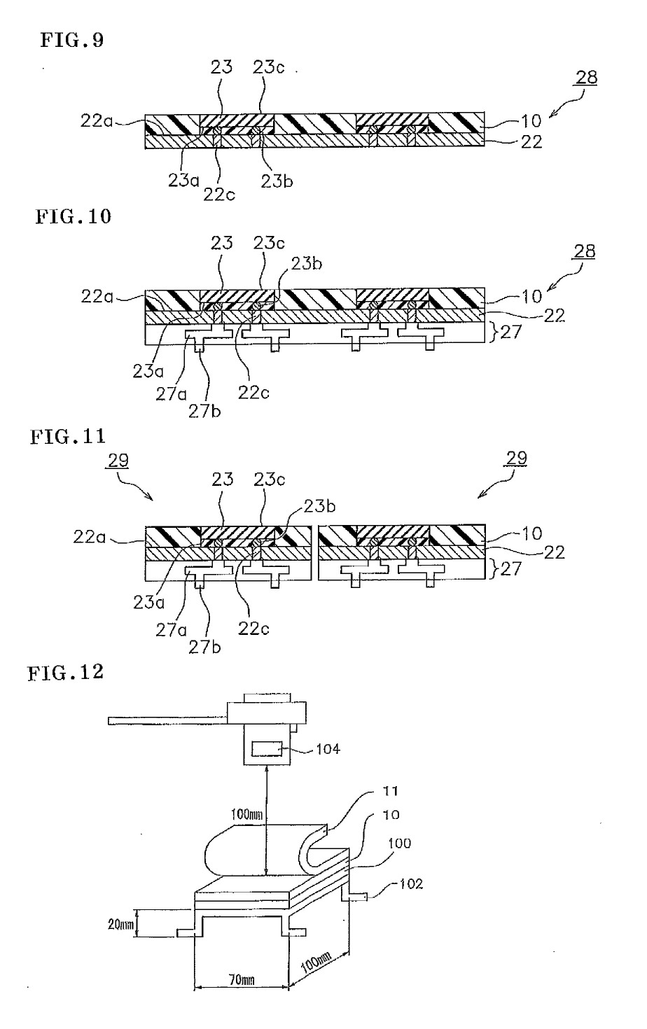

Next, the semiconductor wafer surface opposite to the semiconductor-chip-23-mounted surface of the semiconductor wafer 22 is ground to make vias 22c (see FIG. 9), and then an interconnect layer 27 is formed which has interconnects 27a (see FIG. 10). The method for grinding the semiconductor wafer 22 is not particularly limited, and is, for example, a grinding method using a grinding stone rotatable at a high velocity. Bumps 27b projected from the interconnects 27a may be formed in the interconnect layer 27. It is allowable to apply, to the method of forming the interconnect layer 27, a technique known in the prior art for manufacturing a circuit board or interposer, such as a semi-additive method or a subtractive method. Thus, detailed description thereabout is omitted herein.

### [Dicing Step]

Subsequently, as illustrated in FIG. 11, the sealed body 28 from which the rear surfaces 23c of the semiconductor chips 23 are exposed are diced. Through this step, semiconductor devices 29, which correspond to the respective units of the semiconductor chips 23, can be obtained.

### [Substrate Mounting Step]

As required, a substrate mounting step may be performed in which each of the semiconductor devices 29 is mounted onto a different substrate (not illustrated). For the mounting of the semiconductor device 29 onto the different substrate, a known apparatus such as a flip-chip bonder or die bonder is usable.

According to the above-mentioned method for manufacturing a semiconductor device of the first embodiment, anyone of the surfaces of the sheet 10 for sealing has a surface specific resistance value of 1.0×10¹²Ω or less; thus, the sheet for sealing can exhibit an antistatic effect. As a result, the semiconductor chip 23 can be prevented from being broken by peel electrification generated when the release sheet 11 bonded to the sheet 10 for sealing is peeled therefrom, so that the semiconductor device 29 manufactured using the sheet 10 for sealing can be improved in reliability.

In the first embodiment, a case has been described where the release liner 11 is peeled before the thermal curing step. However, the release liner 11 may be peeled after the thermal curing step.

### Second Embodiment

A method for manufacturing a semiconductor device according to a second embodiment includes at least the following steps:

a step A of fixing a semiconductor chip tentatively onto a tentatively fixing member, and

a step B of embedding the semiconductor chip fixed tentatively onto the tentatively fixing member in a sheet for sealing to form a sealed body,

wherein a surface of the sheet for sealing has a surface specific resistance value of 1.0×10¹²Ω or less.

In other words, in the second embodiment, a case will be described where the “support” in the present invention is a tentatively fixing member. The second embodiment is a method for manufacturing a semiconductor device designated, what is called, a fan-out type wafer level package (WLP).

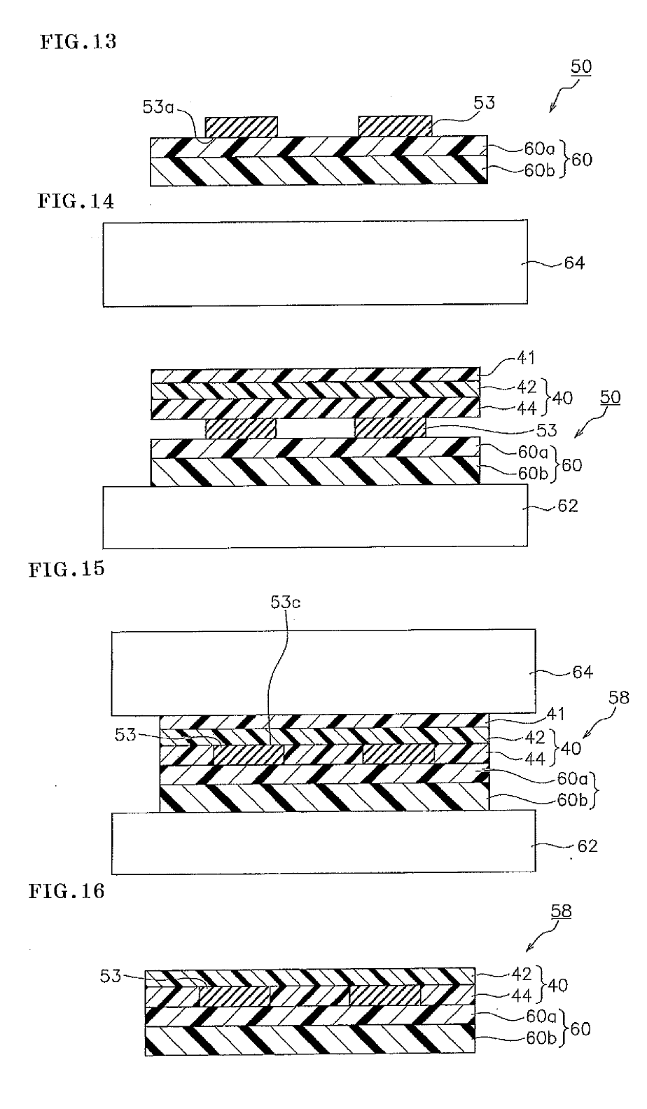

FIG. 13 to FIG. 20 are each a schematic sectional view referred to for describing the method for manufacturing a semiconductor device according to the second embodiment. In the first embodiment, a semiconductor chip flip-chip bonded to a semiconductor wafer is resin-sealed with a sheet for sealing; however, in the second embodiment, a semiconductor chip is resin-sealed in the state of being tentatively fixed not onto any semiconductor wafer but onto a tentatively fixing member.

### [Stacked Body Providing Step]

As illustrated in FIG. 13, in the method for manufacturing a semiconductor device according to the second embodiment, first, one or more semiconductor chips 53 each having a circuit-forming surface 53a, and a tentatively fixing member 60 are provided. In the second embodiment, the tentatively fixing member 60 corresponds to the “support” in the present invention. A stacked body 50 is obtained, for example, as follows.

### <Tentatively Fixing Member Providing Step>

In a tentatively fixing member providing step, provided is a tentatively fixing member 60 in which a thermally expansive pressure-sensitive adhesive layer 60a is stacked on a supporting substrate 60b (see FIG. 13). Instead of the thermally expansive pressure-sensitive adhesive layer, a radiation curable pressure-sensitive adhesive layer is usable. In the present embodiment, a description is made about the tentatively fixing member 60 that is a member having a thermally expansive pressure-sensitive adhesive layer.

### (Thermally Expansive Pressure-Sensitive Adhesive Layer)

The thermally expansive pressure-sensitive adhesive layer 60a may be made of a pressure-sensitive adhesive composition containing a polymer component and a foaming agent. The polymer component (particularly as a base polymer) is preferably an acrylic polymer (which may be referred to as an “acrylic polymer A”). The acrylic polymer A may be a polymer made from a (meth)acrylate as a main monomer component. Examples of the (meth)acrylate include alkyl (meth)acrylates (for example, linear or branched alkyl esters in which the alkyl group has 1 to 30 carbon atoms, in particular, 4 to 18 carbon atoms, examples of these esters including methyl, ethyl, propyl, isopropyl, butyl, isobutyl, sec-butyl, t-butyl, pentyl, isopentyl, hexyl, heptyl, octyl, 2-ethylhexyl, isooctyl, nonyl, decyl, isodecyl, undecyl, dodecyl, tridecyl, tetradecyl, hexadecyl, octadecyl, and eicosyl esters); and cycloalkyl (meth)acrylates (for example, cyclopentyl and cyclohexyl esters). These (meth)acrylates may be used alone or in any combination of two or more thereof.

The acrylic polymer A may contain a unit corresponding to a different monomer component copolymerizable with the (meth)acrylate, as required, in order to be improved in cohesive strength, heat resistance, crosslinkability and others. Examples of the monomer component include carboxyl group-containing monomers such as acrylic acid, methacrylic acid, itaconic acid, maleic acid, fumaric acid, crotonic acid and carboxyethyl acrylate; acid anhydride group-containing monomers such as maleic anhydride and itaconic anhydride; hydroxyl group-containing monomers such as hydroxyethyl (meth)acrylate, hydroxypropyl (meth)acrylate, and hydroxybutyl (meth)acrylate; (N-substituted or unsubstituted) amide monomers such as (meth)acrylamide, N,N-dimethyl(meth)acrylamide, N-butyl(meth)acrylamide, N-methylol(meth)acrylamide, and N-methylolpropane(meth)acrylamide; vinyl ester monomers such as vinyl acetate and vinyl propionate; styrene, and styrene-based monomers such as α-methylstyrene; vinyl ether monomers such as vinyl methyl ether and vinyl ethyl ether; cyanoacrylate monomers such as acrylonitrile and methacrylonitrile; epoxy group-containing acrylic monomers such as glycidyl (meth)acrylate; olefin or diene monomers such as ethylene, propylene, isoprene, butadiene, and isobutylene; (substituted or unsubstituted) amino group-containing monomers such as aminoethyl (meth)acrylate, N,N-dimethylaminoethyl (meth)acrylate, and t-butylaminoethyl (meth)acrylate; alkoxyalkyl (meth)acrylate monomers such as methoxyethyl (meth)acrylate and ethoxyethyl (meth)acrylate; monomers each having a nitrogen atom-containing ring, such as N-vinylpyrrolidone, N-methylvinylpyrrolidone, N-vinylpyridine, N-vinylpiperidone, N-vinylpyrimidine, N-vinylpiperazine, N-vinylpyrazine, N-vinylpyrrole, N-vinylimidazole, N-vinyloxazole, N-vinylmorpholine, and N-vinylcaprolactam; N-vinyl carboxyamides; sulfonate group-containing monomers such as styrenesulfonic acid, allylsulfonic acid, (meth)acrylamidepropanesulfonic acid, and sulfopropyl (meth)acrylate; phosphate group-containing monomers such as 2-hydroxyethylacryloyl phosphate; maleimide monomers such as N-cyclohexylmaleimide, N-isopropylmaleimide, N-laurylmaleimide, and N-phenylmaleimide; itaconimide monomers such as N-methylitaconimide, N-ethylitaconimide, N-butylitaconimide, N-octylitaconimide, N-2-ethylhexylitaconimide, N-cyclohexylitaconimide, and N-laurylitaconimide; succinimide monomers such as N-(meth)acryloyloxymethylenesuccinimide, N-(meth)acryloyl-6-oxyhexamethylenesuccinimide, and N-(meth)acryloyl-8-oxyoctamethylenesuccinimide; glycol acrylate monomers such as polyethylene glycol (meth)acrylate and polypropylene glycol (meth)acrylate; monomers each having an oxygen atom-containing hetero ring such as tetrahydrofurfuryl (meth)acrylate; fluorine atom-containing acrylate monomers such as fluorine-containing (meth)acrylate; acrylate monomers each containing a silicon atom such as silicone-based (meth)acrylates; and polyfucnitonal monomers such as hexanediol di(meth)acrylate, (poly)ethylene glycol di(meth)acrylate, (poly)propylene glycol di(meth)acrylate, neopentyl glycol di(meth)acrylate, pentaerythritol di(meth)acrylate, trimethylolpropane tri(meth)acrylate, pentaerythritol tri(meth)acrylate, dipentaerythritol hexa(meth)acrylate, epoxy acrylate, polyester acrylate, urethane acrylate, divinylbenzene, butyl di(meth)acrylate, and hexyl di(meth)acrylate.

The acrylic polymer A can be obtained by polymerizing a single monomer species or a mixture of two or more monomer species. The polymerization may be attained by solution polymerization (such as radical polymerization, anionic polymerization or cationic polymerization), emulsion polymerization, bulk polymerization, suspension polymerization, photopolymerization (such as ultraviolet (UV) polymerization), or any other method.

The weight-average molecular weight of the acrylic polymer A is not particularly limited, and is preferably from about 350000 to 1000000, more preferably from about 450000 to 800000.

In the thermally expansive pressure-sensitive adhesive, an external crosslinking agent is appropriately usable to adjust the adhesive strength of the adhesive. A method for the external crosslinking is specifically a method of adding what is called a crosslinking agent to the adhesive to be caused to react with a crosslinkable component in the adhesive, the agent being, for example, a polyisocyanate compound, an epoxy compound or an aziridine compound, or a melamine type crosslinking agent. When the external crosslinking agent is used, the use amount thereof is appropriately decided in accordance with a balance in amount between the agent and the base polymer to be crosslinked, and further the usage of the pressure-sensitive adhesive. The use amount of the external crosslinking agent is generally 20 parts by weight or less (preferably from 0.1 to 10 parts by weight) for 100 parts by weight of the base polymer.

As described above, the thermally expansive pressure-sensitive adhesive layer 60a contains a foaming agent for giving thermal expansivity to this layer. Thus, in a state that a sealed body 58 is formed on the thermally expansive pressure-sensitive adhesive layer 60a of the tentatively fixing member 60 (see FIG. 16), at least a portion of the tentatively fixing member 60 is heated at any time to foam and/or expand the foaming agent contained in the heated portion of the thermally expansive pressure-sensitive adhesive layer 60a. Thus, at least the portion of the thermally expansive pressure-sensitive adhesive layer 60a expands. By the expansion of at least the portion of the thermally expansive pressure-sensitive adhesive layer 60a, the adhesive surface of this layer (the interface thereof with the sealed body 58), which corresponds to the expanding portion, is deformed into a bumpy form to decrease the area of the adhesive surface between the thermally expansive pressure-sensitive adhesive layer 60a and the sealed body 58. The decrease makes it possible to reduce the adhering strength between the two to peel the sealed body 58 from the tentatively fixing member 60 (see FIG. 17).

### (Foaming Agent)

The foaming agent used in the thermally expansive pressure-sensitive adhesive layer 60a is not particularly limited, and is appropriately selectable from known foaming agents. About the foaming agent, a single species thereof or a combination of two or more species thereof may be used. The foaming agent is preferably thermally expansive microspheres.

### (Thermally Expansive Microspheres)

The thermally expansive microspheres are not particularly limited, and are appropriately selectable from known thermally expansive microspheres (such as various inorganic thermally expansive microspheres and organic thermally expansive microspheres). The thermally expansive microspheres are preferably usable in the form of a micro-encapsulated foaming agent from the viewpoint of an easy blending operation thereof, and others. Such thermally expansive microspheres are, for example, microspheres obtained by encapsulating a substance which is heated to be easily gasified and expanded, such as isobutane, propane or pentane, into an elastic shell. In many cases, the shell is made of a thermally meltable substance or a substance which is thermally expansive to be broken. Examples of the substance that forms the shell include a vinylidene chloride-acrylonitrile copolymer, polyvinyl alcohol, polyvinyl butyral, polymethyl methacrylate, polyacrylonitrile, polyvinylidene chloride, and polysulfone.

The thermally expansive microspheres can be produced by a conventional method, such as a coacervation method or interfacial polymerization. The thermally expansive microspheres may be any commercially available product thereof, such as a series of products manufactured by Matsumoto Yushi-Seiyaku Co., Ltd. and each having a trade name “Matsumoto Microsphere” (for example, products having respective trade names “Matsumoto Microsphere F30,” “Matsumoto Microsphere F301D,” “Matsumoto Microsphere F50D,” “Matsumoto Microsphere F501D,” “Matsumoto Microsphere F80SD,” and “Matsumoto MicrosphereF80VSD”), and products manufactured by Expancel and having respective trade names of “051DU,” “053DU,” “551DU,” “551-20DU” and “551-80DU.”

When the thermally expansive microspheres are used as the foaming agent, the particle diameter (average particle diameter) of the thermally expansive microspheres is appropriately selectable in accordance with the thickness of the thermally expansive pressure-sensitive adhesive layer, and others. The average particle diameter of the thermally expansive microspheres is selectable from, for example, a range of diameters of 100 μm or less (preferably of 80 μm or less, more preferably from 1 to 50 μm, in particular from 1 to 30 μm). The adjustment of the particle diameter of the thermally expansive microspheres may be made in a process of producing the thermally expansive microspheres, or may be made by, for example, classification, after the production. The thermally expansive microspheres are preferably made even in particle diameter.

### (Other Foaming Agents)

In the present embodiment, as the foaming agent, a foaming agent other than the thermally expansive microspheres may be used. The foaming agent is appropriately selectable from various foaming agents such as various inorganic foaming agents and organic foaming agents and used. Typical examples of the inorganic foaming agents include ammonium carbonate, ammonium hydrogencarbonate, sodium hydrogencarbonate, ammonium nitrite, sodium borohydride, and various azides.

Typical examples of the organic foaming agents include water; fluoroalkane compounds such as trichloromonofluoromethane and dichloromonofluoromethane; azo compounds such as azobisisobutyronitrile, azodicarbonamide, and barium azodicarboxylate; hydrazine-based compounds such as p-toluenesulfonylhydrazide, diphenylsulfone-3,3′-disulfonylhydrazide, 4,4′-oxybis(benzenesulfonylhydrazide), and allylbis(sulfonylhydrazide); semicarbazide compounds such as p-toluylenesulfonylsemicarbazide and 4,4′-oxybis(benzenesulfonylsemicarbazide); triazole compounds such as 5-morpholyl-1,2,3,4-thiatriazole; and N-nitroso compounds such as N,N′-dinitrosopentamethylenetetramine and N,N′-dimethyl-N,N′-dinitrosoterephthalamide.

In the present embodiment, preferred is a foaming agent having such an appropriate strength that the agent does not burst until the volume expansion coefficient thereof turns to 5 times or more, more restrictedly 7 times or more, in particular 10 times or more in order to cause the thermally expansive pressure-sensitive adhesive layer to be efficiently and stably lowered in adhering strength by heating.

The blend amount of the foaming agent (such as the thermally expansive microspheres) can be appropriately set in accordance with the expansion coefficient of the thermally expansive pressure-sensitive adhesive layer, the property of lowering the adhering strength of the layer, and others. The blend amount is generally from, for example, 1 to 150 parts by weight (preferably from 10 to 130 parts by weight, more preferably from 25 to 100 parts by weight) for 100 parts by weight of the base polymer which forms the thermally expansive pressure-sensitive adhesive layer.

In the present embodiment, it is proper to use, as the foaming agent, an agent having a foaming starting temperature (thermal expansion starting temperature) (T₀) ranging from 80 to 210° C., preferably from 90 to 200° C. (more preferably from 95 to 200° C., in particular preferably from 100 to 170° C.). If the foaming starting temperature of the foaming agent is lower than 80° C., the foaming agent may be unfavorably foamed by heat when the sealed body is produced or used. Thus, the foaming agent is lowered in handleability, and semiconductor devices to be obtained are lowered in productivity. In the meantime, if the foaming starting temperature of the foaming agent is higher than 210° C., the supporting substrate of the tentatively fixing member, and the sealing resin need to have excessive heat resistance so that an unfavorable effect is produced on the handleability, the productivity, and costs. The foaming starting temperature (T₀) of the foaming agent corresponds to the foaming starting temperature (T₀) of the thermally expansive pressure-sensitive adhesive layer.

The method for foaming the foaming agent (i.e., the method for thermally expanding the thermally expansive pressure-sensitive adhesive layer) is appropriately selected from known heating foaming methods and adopted.

In the present embodiment, the thermally expansive pressure-sensitive adhesive layer has, at 23 to 150° C., an elastic modulus preferably from 5×10⁴ to 1×10⁶ Pa, more preferably from 5×10⁴ to 8×10⁵ Pa, in particular from 5×10⁴ to 5×10⁵ Pa in the form of containing no foaming agent from the viewpoint of a balance between an appropriate adhering strength before the heating and a lowered adhering strength after the heating. If the layer has an elastic modulus (temperature: 23 to 150° C.) less than 5×10⁴ Pa in the form of containing no foaming agent, the layer is poor in thermal expansivity so that the tentatively fixing member may be lowered in peeling performance. If the layer has an elastic modulus (temperature: 23 to 150° C.) larger than 1×10⁶ Pa in the form of containing no foaming agent, the layer may be poor in initial adhesion.

The thermally expansive pressure-sensitive adhesive layer in the form of containing no foaming agent corresponds to a pressure-sensitive adhesive layer made of the pressure-sensitive adhesive (but containing no foaming agent). Accordingly, the elastic modulus of the thermally expansive pressure-sensitive adhesive layer in the form of containing no foaming agent is measurable using the pressure-sensitive adhesive (containing no foaming agent). The thermally expansive pressure-sensitive adhesive layer can be formed using a thermally expansive pressure-sensitive adhesive containing a pressure-sensitive adhesive capable of forming a pressure-sensitive adhesive layer having an elastic modulus of 5×10⁴ to 1×10⁶ Pa at 23 to 150° C., and a foaming agent.

The elastic modulus of the thermally expansive pressure-sensitive adhesive layer in the form of containing no foaming agent is measured by producing the thermally expansive pressure-sensitive adhesive layer in the form of containing no foaming agent (i.e., the pressure-sensitive adhesive layer made of the pressure-sensitive adhesive containing no foaming agent) (as a sample), and making a measurement using a dynamic viscoelasticity measuring instrument “ARES” manufactured by Rheometric in a shear mode using a parallel plate tool having a diameter of 7.9 mm under the following conditions: a sample thickness of about 1.5 mm, a frequency of 1 Hz, a heating rate of 5° C./minute, and each of a strain of 0.1% (at 23° C.) and a strain of 0.3% (at 150° C.). The elastic modulus is defined as a value of the shear storage modulus G′ obtained at each of the temperatures of 23° C. and 150° C.

The elastic modulus of the thermally expansive pressure-sensitive adhesive layer is controllable by adjusting the kind of the base polymer of the pressure-sensitive adhesive, the crosslinking agent, additives and others.

The thickness of the thermally expansive pressure-sensitive adhesive layer is not particularly limited, and is appropriately selectable in accordance with the above-mentioned adhering-strength-lowering property of this layer, and others. The thickness is, for example, from about 5 to 300 μm (preferably from about 20 to 150 μm). However, when the thermally expansive microspheres are used as the foaming agent, the thickness of the thermally expansive pressure-sensitive adhesive layer is preferably made larger than the maximum particle diameter of the contained thermally expansive microspheres. If the thickness of the thermally expansive pressure-sensitive adhesive layer is too small, the layer is damaged in surface smoothness by bumpiness based on the thermally expansive microspheres to be lowered in adhesion before heated (in a non-foamed state). Moreover, the thermally expansive pressure-sensitive adhesive layer is small in deformation degree based on the heating not to be smoothly lowered in adhering strength. In the meantime, if the thickness of the thermally expansive pressure-sensitive adhesive layer is too large, cohesive failure is easily generated in the thermally expansive pressure-sensitive adhesive layer after the expansion or foaming by the heating. Thus, an adhesive residue may be generated in the sealed body 58.

The thermally expansive pressure-sensitive adhesive layer may have a monolayered or multilayered structure.

In the present embodiment, the thermally expansive pressure-sensitive adhesive layer may contain various additives (such as a colorant, a thickener, an extender, a filler, a tackifier, a plasticizer, an antiaging agent, an antioxidant, a surfactant, and a crosslinking agent).

### (Supporting Substrate)

The supporting substrate 60b is a thin plate-shaped member functioning as a strength base for the tentatively fixing member 60. The material of the supporting substrate 60b may be appropriately selected, considering the handleability and the heat resistance thereof, and others. Examples of the material include metal materials such as SUS; plastic materials such as polyimide, polyamideimide, polyetheretherketone, and polyethersulfone; glass; and a silicon wafer. A plate of SUS, out of these materials, is preferred from the viewpoint of the heat resistance, the strength, the reusability, and others.

The thickness of the supporting substrate 60b is appropriately selectable considering a target strength thereof and the handleability. The thickness is preferably from 100 to 5000 μm, more preferably from 300 to 2000 μm.

### (Method for Forming Tentatively Fixing Member)

The tentatively fixing member 60 is obtained by forming the thermally expansive pressure-sensitive adhesive layer 60a onto the supporting substrate 60b. The thermally expansive pressure-sensitive adhesive layer can be formed by, for example, a conventional method of mixing a pressure-sensitive adhesive, a foaming agent (such as thermally expansive microspheres), and a solvent, other additives and so on that are optionally used, and then forming the mixture into a layer in a sheet form. Specifically, the thermally expansive pressure-sensitive adhesive layer can be formed by, for example, a method of applying, onto the supporting substrate 60b, a mixture containing a pressure-sensitive adhesive, a foaming agent (such as thermally expansive microspheres), and a solvent and other additives that are optionally used, or a method of applying the same mixture onto an appropriate separator (such as a release paper piece) to forma thermally expansive pressure-sensitive adhesive layer, and transferring (transcribing) this layer onto the supporting substrate 60b.

### (Method for Thermally Expanding Thermally Expansive Pressure-Sensitive Adhesive Layer)

In the present embodiment, the thermally expansive pressure-sensitive adhesive layer can be thermally expanded by heating. The method for the heating can be performed using, for example, an appropriate heating means such as a hot plate, a hot air drier, a near infrared lamp or an air drier. In the heating, it is sufficient for the heating temperature to be not lower than the foaming starting temperature (thermal expansion starting temperature) of the foaming agent (such as the thermally expansive microspheres) in the thermally expansive pressure-sensitive adhesive layer. Conditions for the heating may be appropriately set in accordance with the reduction property of the adhesive surface area, the property being dependent on the kind of the foaming agent (such as the thermally expansive microspheres) and others, the heat resistance of the sealed body containing the supporting substrate and the semiconductor chips or of others, the heating method (the thermal capacity and the heating means, and others), and others. The heating conditions are generally as follows: a temperature of 100 to 250° C., and a period of 1 to 90 seconds (according to, for example, a hot plate), or a period of 5 to 15 minutes (according to, for example, a hot air drier). The heating may be performed at an appropriate stage in accordance with a purpose of the use. As a heat source in the heating, an infrared lamp or heated water may be usable.

### (Intermediate Layer)

In the present embodiment, an intermediate layer (not illustrated) may be laid between the thermally expansive pressure-sensitive adhesive layer 60a and the supporting substrate 60b, for example, to improve the two in adhesion, or improve the two in peeling performance after heating. It is preferred to lay, as the intermediate layer, a rubbery organic elastic intermediate layer. The laying of the rubbery organic elastic intermediate layer makes the following possible: when the semiconductor chips 53 are bonded to the tentatively fixing member 60 (see FIG. 13), the outer surface of the thermally expansive pressure-sensitive adhesive layer 60a is caused to follow the outer surface shape of the semiconductor chips 53 satisfactorily to increase the adhesive surface area; and further when the sealed body 58 is heated and peeled from the tentatively fixing member 60, the thermal expansion of the thermally expansive pressure-sensitive adhesive layer 60a is controlled at a high level (with good precision) to expand the thermally expansive pressure-sensitive adhesive layer 60a evenly and preferentially in the thickness direction.

The rubbery organic elastic intermediate layer may be caused to be laid on one surface or each surface of the supporting substrate 60b.

It is preferred to form the rubbery organic elastic intermediate layer using, for example, a natural rubber, a synthetic rubber or a rubbery elastic synthetic resin having a Shore D harness of 50 or less, in particular, 40 or less according to ASTM D-2240. For reference, even when a polymer is essentially a hard polymer, such as polyvinyl chloride, the polymer can exhibit rubbery elasticity by combining the polymer with an agent to be blended such as a plasticizer or a softener. Such a composition is also usable as the constituent material of the rubbery organic elastic intermediate layer.

The rubbery organic elastic intermediate layer can be formed by, for example, a method (coating method) of applying, onto a substrate, a coating liquid containing a forming material for the rubbery organic elastic intermediate layer, such as the above-mentioned natural rubber, synthetic rubber or rubbery elastic synthetic resin, a method (dry laminating method) of bonding, to a substrate, a film made of a forming material for the rubbery organic elastic intermediate layer, or a stacked film in which a layer made of a forming material for the rubbery organic elastic intermediate layer is beforehand formed on one or more thermally expansive pressure-sensitive adhesive layers, or a method (co-extrusion method) of co-extruding a resin composition containing a constituent material for a substrate, and a resin composition containing a forming material for the rubbery organic elastic intermediate layer.

The rubbery organic elastic intermediate layer may be made of an adhesive material made mainly of a natural rubber, a synthetic rubber or a rubbery elastic synthetic resin, or may be, for example, a foamable film made mainly of such components. The foaming of the foamable film may be attained by a conventional method such as a mechanical agitation method, a method using a reaction-produced gas, a method using a foaming agent, a method of removing a soluble substance, a spraying method, a method of forming a syntactic foam, or a sintering method.

The thickness of the rubbery organic elastic intermediate layer or any other intermediate layer is, for example, from about 5 to 300 μm, preferably from about 20 to 150 μm. In the case of, for example, the rubbery organic elastic intermediate layer, if the thickness of the rubbery organic elastic intermediate layer is too small, the layer cannot produce any three-dimensional structure change after heated to be foamed. Thus, the layer may be deteriorated in peeling property.

The rubbery organic elastic intermediate layer or any other intermediate layer may have a monolayered structure, or a structure having two or more layers.

The intermediate layer may contain various additives (such as a colorant, a thickener, an extender, a filler, a tackifier, a plasticizer, an antiaging agent, an antioxidant, a surfactant, and a crosslinking agent) as far as the additives do not damage the effects and advantages of the tentatively fixing member.

### <Semiconductor Chip Tentatively-Fixing Step>

As illustrated in FIG. 13, in a semiconductor chip tentatively-fixing step, semiconductor chips 53 are arranged onto the tentatively fixing member 60 to face their circuit-forming surfaces 53a to the tentatively fixing member 60. In this way, the semiconductor chips 53 are tentatively fixed (step A). For the tentative fixing of the semiconductor chips 53, a known apparatus, such as a flip chip bonder or a die bonder, is usable.

The layout of the semiconductor chips 53 and the number of the chips 53 to be arranged may be appropriately set in accordance with the shape or size of the tentatively fixing member 60, the number of target packages to be produced, and others. The semiconductor chips 53 may be arranged into the form of a matrix having plural rows and plural columns. The above has described an example of the stacked body providing step.

### [Step of Providing Sheet for Sealing]

As illustrated in FIG. 14, in the method for manufacturing a semiconductor device according to the second embodiment, a sheet 40 for sealing is provided. The sheet 40 for sealing is usually provided in the state of being stacked onto a release liner 41 such as a polyethylene terephthalate (PET) film. In this case, the release liner 41 may be subjected to release treatment for attaining the peeling of the sheet 40 for sealing easily.

### (Sheet for Sealing)

A surface of the sheet 40 for sealing has a surface specific resistance value of 1.0×10¹²Ω or less. The raw material, physical properties and others of the sheet 40 for sealing may be made equivalent to those of the sheet 10 for sealing. The raw material, physical properties and others of the release liner 41 may be made equivalent to those of the release liner 11. Thus, description thereabout is omitted herein.

### [Step of Arranging Sheet for Sealing and Stacked Body]

As illustrated in FIG. 14, after the step of providing the sheet for sealing, the stacked body 50 is arranged onto a lower heating plate 62 to face the semiconductor-chip-53-tentatively-fixed surface of the stacked body 50 upward, and further the sheet 40 for sealing is arranged onto the semiconductor-chip-53-tentatively-fixed surface of the stacked body 50. As has been illustrated in FIG. 14, the sheet 40 for sealing is arranged to cause a surface thereof that is opposite to the tentative-fixing-member-60-faced surface thereof to be included in a hard layer 42. In this step, it is allowable to arrange the stacked body 50 initially onto the lower heating plate 62, and then arrange the sheet 40 for sealing onto the stacked body 50, or stack the sheet 40 for sealing onto the stacked body 50, and then arrange the resultant stacked product, in which the stacked body 50 and the sheet 40 for sealing are stacked onto each other, onto the lower heating plate 62.

### [Step of Forming Sealed Body]

Next, as illustrated in FIG. 15, the lower heating plate 62 and an upper heating plate 64 are used to hot-press the stacked body, thereby embedding the semiconductor chips 53 in an embedding resin layer 44 of the sheet 40 for sealing. In this way, a sealed body 58 is formed in which the semiconductor chips 53 are embedded in the sheet 40 for sealing (step B).

Conditions for the hot pressing when the semiconductor chips 53 are embedded in the sheet 40 for sealing may be equivalent to those in the first embodiment.

### [Release Liner Peeling Step]

Next, the release liner 41 is peeled (see FIG. 16). At this time, the stacked body is not easily electrified since the surface specific resistance value of the sheet 40 for sealing is 1.0×10¹²Ω or less. Accordingly, the sheet 40 for sealing can further exhibit an antistatic effect. As a result, the semiconductor chips 53 can be prevented from being broken by the peel electrification, so that an improvement can be made in the reliability of semiconductor devices 59 (see FIG. 20) each manufactured using the sheet 40 for sealing.

### [Thermal Curing Step]

Next, the sheet 40 for sealing is thermally cured. In particular, the embedding resin layer 44 of the sheet 40 for sealing is thermally cured. Specifically, for example, the whole of the sealed body 58 is heated, in which the semiconductor chips 53 fixed tentatively on the tentatively fixing member 60 are embedded in the sheet 40 for sealing.

Conditions for the thermal curing may be equivalent to those in the first embodiment.

### [Step of Peeling Thermally Expansive Pressure-Sensitive Adhesive Layer]

Next, as illustrated in FIG. 17, the tentatively fixing member 60 is heated to thermally expand the thermally expansive pressure-sensitive adhesive layer 60a to peel the thermally expansive pressure-sensitive adhesive layer 60a and the sealed body 58 from each other. Alternatively, the following method is also preferably adoptable: a method of peeling the supporting substrate 60b and the thermally expansive pressure-sensitive adhesive layer 60a from each other at the interface therebetween, and then peeling the thermally expansive pressure-sensitive adhesive layer 60a and the sealed body 58 from each other at the interface therebetween by thermal expansion. In any one of these cases, the thermally expansive pressure-sensitive adhesive layer 60a is heated to be thermally expanded, thereby being lowered in adhesive strength to make it possible to peel the thermally expansive pressure-sensitive adhesive layer 60a and the sealed body 58 easily from each other at the interface therebetween. It is preferred to adopt, as conditions for the thermal expansion, the conditions in the above-mentioned column “Method for Thermally Expanding Thermally Expansive Pressure-Sensitive Adhesive Layer.” The thermally expansive pressure-sensitive adhesive layer is in particular preferably formed to have a structure permitting this layer not to be peeled by the heating in the above-mentioned thermal curing step but to be peeled by the heating in this step of peeling the thermally expansive pressure-sensitive adhesive layer.

### [Step of Grinding Sheet for Sealing]

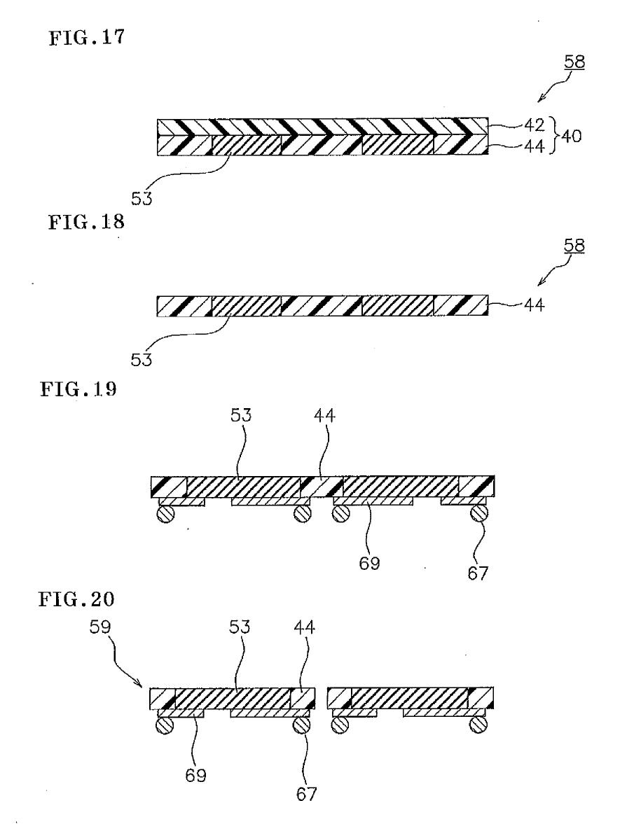

Next, as illustrated in FIG. 18, the sheet 40 for sealing in the sealed body 58 is ground to expose the respective rear surfaces 53c of the semiconductor chips 53 (step C). The method for grinding the sheet 40 for sealing is not particularly limited, and may be, for example, a grinding method using a grinding stone rotatable at a high velocity.

### (Re-Interconnect Forming Step)

The present embodiment preferably includes a re-interconnect forming step of forming re-interconnects 69 on the circuit-forming surfaces 53a of the semiconductor chips 53 of the sealed body 58. In the re-interconnect forming step, after the peeling of the thermally expansive pressure-sensitive adhesive layer 60a, the re-interconnects 69, which are connected to the exposed semiconductor chips 53, are formed on the sealed body 58 (see FIG. 19).

In a method for forming the re-interconnects, for example, a known method such as a vacuum-deposition method is used to form a metal seed layer onto the exposed semiconductor chips 53, and then the re-interconnects 69 can be formed by a known method such as a semi-additive method.

Thereafter, an insulating layer of, for example, polyimide or PBO may be formed on the re-interconnects 69 and the sealed body 58.

### (Bump Forming Step)

Next, a bumping processing may be performed in which bumps 67 are formed on the formed re-interconnects 69 (see FIG. 19). The bumping processing may be performed by a known method using, for example, solder balls or solder plating. It is preferred to use, as the material of the bumps 67, the same material as used in the first embodiment.

### (Dicing Step)

Lastly, the stacked body, which is composed of the semiconductor chips 53, the sheet 21 for sealing, the re-interconnects 69, and the other elements, is diced (see FIG. 20). This step can give the semiconductor devices 59 in the state that the interconnects are led to the outside of the chip regions. The method for the dicing may be the same as used in the first embodiment. The above has described the second embodiment.

The present invention is not limited to the first and second embodiments. In the present invention, it is sufficient for only the steps A and B to be performed. The other steps are each an optional step, and may or may not be performed.

In the embodiments, cases has been described where a sheet for sealing is used to embed flip-chip bonded semiconductor chips in a semiconductor wafer (the first embodiment), and where semiconductor chips fixed tentatively onto a tentatively fixing member are embedded (the second embodiment). However, the sheet of the present invention for sealing is not limited to these examples as far as the sheet is used in a method for manufacturing a semiconductor device using the embedment of a semiconductor chip. The sheet for sealing is usable in any case of embedding a flip-chip bonded or die-bonded semiconductor chip in a substrate that may be of various types (such as a lead frame or an interconnect circuit board) to manufacture a semiconductor device.

### EXAMPLES

Hereinafter, the present invention will be described in detail by way of examples thereof. However, the invention is not limited to the examples as far as any other example does not depart from the subject matters of the present invention. In each of the examples, the word “part(s)” denotes part(s) by weight unless otherwise specified.

### Example 1

### Production of Each Sheet for Sealing

In 100 parts of an epoxy resin (trade name: “YSLV-80XY,” manufactured by Nippon Steel Chemical Co., Ltd.) were blended 110 parts of a phenolic resin (trade name: “MEH-7851-SS,” manufactured by MEIWA PLASTIC INDUSTRIES, LTD.), 2350 parts of a spherical filler (trade name: “FB-9454FC,” manufactured by Denki Kagaku Kogyo K.K.), 2.5 parts of a silane coupling agent (trade name: “KBM-403,” manufactured by Shin-Etsu Chemical Co., Ltd.), 13 parts of carbon black (trade name: “#20,” manufactured by Mitsubishi Chemical Corporation), 3.5 parts of a curing accelerator (trade name: “2PHZ-PW,” manufactured by Shikoku Chemicals Corporation), 100 parts of a thermoplastic resin (trade name: “SIBSTAR 072T,” manufactured by Kaneka Corporation), and an antistatic agent (product name: “PELESTAT,” manufactured by Sanyo Chemical Industries, Ltd.), the proportion of this agent being 50% by weight of the entire resin components other than the filler. A roll kneader was used to heat the mixture at 60° C. for 2 minutes, at 80° C. for 2 minutes and at 120° C. for 6 minutes in this order to melt and knead the mixture under a reduced pressure (0.01 kg/cm²) for the total period of 10 minutes, thereby preparing a kneaded product. Next, the resultant kneaded product was applied to a release-treated film at 120° C. to be made into a sheet form, using a slot die method. The same release-treated film was laminated onto the sheet at a temperature of 60° C. In this way, each sheet for sealing was produced which had a thickness of 400 μm, a length of 350 mm and a width of 350 mm. The used release-treated films were each a polyethylene terephthalate film release-treated with silicone and having a thickness of 50 μm.

### Example 2

### Production of Each Sheet for Sealing

In 100 parts of an epoxy resin (trade name: “YSLV-80XY,” manufactured by Nippon Steel Chemical Co., Ltd.) were blended 110 parts of a phenolic resin (trade name: “MEH-7851-SS,” manufactured by MEIWA PLASTIC INDUSTRIES, LTD.), 2350 parts of a spherical filler (trade name: “FB-9454FC,” manufactured by Denki Kagaku Kogyo K.K.), 2.5 parts of a silane coupling agent (trade name: “KBM-403,” manufactured by Shin-Etsu Chemical Co., Ltd.), 13 parts of carbon black (trade name: “#20,” manufactured by Mitsubishi Chemical Corporation), 3.5 parts of a curing accelerator (trade name: “2PHZ-PW,” manufactured by Shikoku Chemicals Corporation), 100 parts of a thermoplastic resin (trade name: “SIBSTAR 072T,” manufactured by Kaneka Corporation), and an antistatic agent (product name: “PELESTAT,” manufactured by Sanyo Chemical Industries, Ltd.), the proportion of this agent being 5% by weight of the entire resin components other than the filler. A roll kneader was used to heat the mixture at 60° C. for 2 minutes, at 80° C. for 2 minutes and at 120° C. for 6 minutes in this order to melt and knead the mixture under a reduced pressure (0.01 kg/cm²) for the total period of 10 minutes, thereby preparing a kneaded product. Next, the resultant kneaded product was applied to a release-treated film at 120° C. to be made into a sheet form, using a slot die method. The same release-treated film was laminated onto the sheet at 60° C. In this way, each sheet for sealing was produced which had a thickness of 400 μm, a length of 350 mm and a width of 350 mm. The used release-treated films were each a polyethylene terephthalate film release-treated with silicone and having a thickness of 50 μm.

### Example 3

### Production of Each Sheet for Sealing

### (Production of Each Outermost Layer)

In 100 parts of an epoxy resin (trade name: “YSLV-80XY,” manufactured by Nippon Steel Chemical Co., Ltd.) were blended 110 parts of a phenolic resin (trade name: “MEH-7851-SS,” manufactured by MEIWA PLASTIC INDUSTRIES, LTD.), 2350 parts of a spherical filler (trade name: “FB-9454FC,” manufactured by Denki Kagaku Kogyo K.K.), 2.5 parts of a silane coupling agent (trade name: “KBM-403,” manufactured by Shin-Etsu Chemical Co., Ltd.), 13 parts of carbon black (trade name: “#20,” manufactured by Mitsubishi Chemical Corporation), 3.5 parts of a curing accelerator (trade name: “2PHZ-PW,” manufactured by Shikoku Chemicals Corporation), 100 parts of a thermoplastic resin (trade name: “SIBSTAR 072T,” manufactured by Kaneka Corporation), and an antistatic agent (product name: “PELESTAT,” manufactured by Sanyo Chemical Industries, Ltd.), the proportion of this agent being 50% by weight of the entire resin components other than the filler. A roll kneader was used to heat the mixture at 60° C. for 2 minutes, at 80° C. for 2 minutes and at 120° C. for 6 minutes in this order to melt and knead the mixture under a reduced pressure (0.01 kg/cm²) for the total period of 10 minutes, thereby preparing a kneaded product. Next, the resultant kneaded product was applied to a release-treated film at 120° C. to be made into a sheet form, using a slot die method. In this way, each outermost layer was produced which had a thickness of 200 μm, a length of 350 mm and a width of 350 mm. The used release-treated film was a polyethylene terephthalate film release-treated with silicone and having a thickness of 50 μm.

### (Production of Each Innermost Layer)

In 100 parts of an epoxy resin (trade name: “YSLV-80XY,” manufactured by Nippon Steel Chemical Co., Ltd.) were blended 110 parts of a phenolic resin (trade name: “MEH-7851-SS,” manufactured by MEIWA PLASTIC INDUSTRIES, LTD.), 2080 parts of a spherical filler (trade name: “FB-9454FC,” manufactured by Denki Kagaku Kogyo K.K.), 2.2 parts of a silane coupling agent (trade name: “KBM-403,” manufactured by Shin-Etsu Chemical Co., Ltd.), 11 parts of carbon black (trade name: “#20,” manufactured by Mitsubishi Chemical Corporation), 3.6 parts of a curing accelerator (trade name: “2PHZ-PW,” manufactured by Shikoku Chemicals Corporation), and 65 parts of a thermoplastic resin (trade name: “SIBSTAR 072T,” manufactured by Kaneka Corporation). A roll kneader was used to heat the mixture at 60° C. for 2 minutes, at 80° C. for 2 minutes and at 120° C. for 6 minutes in this order to melt and knead the mixture under a reduced pressure (0.01 kg/cm²) for the total period of 10 minutes, thereby preparing a kneaded product. Next, the resultant kneaded product was applied to a release-treated film at 120° C. to be made into a sheet form, using a slot die method. In this way, each innermost layer was produced which had a thickness of 200 μm, a length of 350 mm and a width of 350 mm. The used release-treated film was a polyethylene terephthalate film release-treated with silicone and having a thickness of 50 μm.

A laminator was used to bond any one of the produced outermost layers onto any one of the produced innermost layers at a temperature of 60° C. to produce each sheet according to the present Example 3 for sealing, the thickness of which was 400 μm.

### Example 4

### Production of Each Sheet for Sealing

### (Production of Each Outermost Layer)

Each outermost layer according to the present Example 4 was produced in the same way as used for the outermost layer in Example 3 except that the content of the antistatic agent in the outermost layer in Example 3 was changed to 5% by weight.

### (Production of Each Innermost Layer)

Each innermost layer equivalent to the innermost layer in Example 3 was produced.

A laminator was used to bond any one of the produced outermost layers onto any one of the produced innermost layers at a temperature of 60° C. to produce each sheet according to the present Example 4 for sealing, the thickness of which was 400 μm.

### Example 5

### Production of Each Sheet for Sealing

### (Production of Each Outermost Layer)

In 100 parts of an epoxy resin (trade name: “YSLV-80XY,” manufactured by Nippon Steel Chemical Co., Ltd.) were blended 110 parts of a phenolic resin (trade name: “MEH-7851-SS,” manufactured by MEIWA PLASTIC INDUSTRIES, LTD.), 2350 parts of a spherical filler (trade name: “FB-9454FC,” manufactured by Denki Kagaku Kogyo K.K.), 2.5 parts of a silane coupling agent (trade name: “KBM-403,” manufactured by Shin-Etsu Chemical Co., Ltd.), 13 parts of carbon black (trade name: “#20,” manufactured by Mitsubishi Chemical Corporation), 3.5 parts of a curing accelerator (trade name: “2PHZ-PW,” manufactured by Shikoku Chemicals Corporation), and 100 parts of a thermoplastic resin (trade name: “SIBSTAR 072T,” manufactured by Kaneka Corporation). A roll kneader was used to heat the mixture at 60° C. for 2 minutes, at 80° C. for 2 minutes and at 120° C. for 6 minutes in this order to melt and knead the mixture under a reduced pressure (0.01 kg/cm²) for the total period of 10 minutes, thereby preparing a kneaded product. Next, the resultant kneaded product was applied to a release-treated film at 120° C. to be made into a sheet form, using a slot die method. In this way, each innermost layer was produced which had a thickness of 200 μm, a length of 350 mm and a width of 350 mm. The used release-treated film was a polyethylene terephthalate film release-treated with silicone and having a thickness of 50 μm.

### (Production of Each Innermost Layer)

In 100 parts of an epoxy resin (trade name: “YSLV-80XY,” manufactured by Nippon Steel Chemical Co., Ltd.) were blended 110 parts of a phenolic resin (trade name: “MEH-7851-SS,” manufactured by MEIWA PLASTIC INDUSTRIES, LTD.), 2080 parts of a spherical filler (trade name: “FB-9454FC,” manufactured by Denki Kagaku Kogyo K.K.), 2.2 parts of a silane coupling agent (trade name: “KBM-403,” manufactured by Shin-Etsu Chemical Co., Ltd.), 11 parts of carbon black (trade name: “#20,” manufactured by Mitsubishi Chemical Corporation), 3.6 parts of a curing accelerator (trade name: “2PHZ-PW,” manufactured by Shikoku Chemicals Corporation), 65 parts of a thermoplastic resin (trade name: “SIBSTAR 072T,” manufactured by Kaneka Corporation), and an antistatic agent (product name: “PELESTAT,” manufactured by Sanyo Chemical Industries, Ltd.), the proportion of this agent being 50% by weight of the entire resin components other than the filler. A roll kneader was used to heat the mixture at 60° C. for 2 minutes, at 80° C. for 2 minutes and at 120° C. for 6 minutes in this order to melt and knead the mixture under a reduced pressure (0.01 kg/cm²) for the total period of 10 minutes, thereby preparing a kneaded product. Next, the resultant kneaded product was applied to a release-treated film at 120° C. to be made into a sheet form, using a slot die method. In this way, each innermost layer was produced which had a thickness of 200 μm, a length of 350 mm and a width of 350 mm. The used release-treated film was a polyethylene terephthalate film release-treated with silicone and having a thickness of 50 μm.

A laminator was used to bond any one of the produced outermost layers onto any one of the produced innermost layers at a temperature of 60° C. to produce each sheet according to the present Example 5 for sealing, the thickness of which was 400 μm.

### Example 6

### Production of Each Sheet for Sealing

### (Production of Each Outermost Layer)

Each outermost layer equivalent to the outermost layer in Example 5 was produced.

### (Production of Each Innermost Layer)

Each outermost layer according to the present Example 6 was produced in the same way as used for the innermost layer in Example 5 except that the content of the antistatic agent in the innermost layer in Example 5 was changed to 5% by weight.

A laminator was used to bond any one of the produced outermost layers onto any one of the produced innermost layers at a temperature of 60° C. to produce each sheet according to the present Example 1 for sealing, the thickness of which was 400 μm.

### Example 7

### Production of Each Antistatic Release Sheet

For forming each release liner (separator), an antistatic layer forming solution D was applied to a surface of a polyethylene terephthalate film release-treated with silicone and having a thickness of 50 μm, this surface being a surface of the film that was opposite to the silicone-release-treated surface of this film. The film was then heated and dried at 60° C. for 1 minute to form each antistatic layer having a thickness of about 100 nm. The used antistatic layer forming solution D was prepared by using, as an antistatic agent, a product with a product name of SEPLEGYDA (compound name: polythiophene), and dispersing this agent in a methyl ethyl ketone (MEK) solvent to give a concentration of 1%.

### <Production of Each Sheet for Sealing>

In 100 parts of an epoxy resin (trade name: “YSLV-80XY,” manufactured by Nippon Steel Chemical Co., Ltd.) were blended 110 parts of a phenolic resin (trade name: “MEH-7851-SS,” manufactured by MEIWA PLASTIC INDUSTRIES, LTD.), 2350 parts of a spherical filler (trade name: “FB-9454FC,” manufactured by Denki Kagaku Kogyo K.K.), 2.5 parts of a silane coupling agent (trade name: “KBM-403,” manufactured by Shin-Etsu Chemical Co., Ltd.), 13 parts of carbon black (trade name: “#20,” manufactured by Mitsubishi Chemical Corporation), 3.5 parts of a curing accelerator (trade name: “2PHZ-PW,” manufactured by Shikoku Chemicals Corporation), and 100 parts of a thermoplastic resin (trade name: “SIBSTAR 072T,” manufactured by Kaneka Corporation). A roll kneader was used to heat the mixture at 60° C. for 2 minutes, at 80° C. for 2 minutes and at 120° C. for 6 minutes in this order to melt and knead the mixture under a reduced pressure (0.01 kg/cm²) for the total period of 10 minutes, thereby preparing a kneaded product. Next, the resultant kneaded product was applied to the silicone-treated surface of the above-mentioned antistatic release sheet at 120° C., using a slot die method. The same antistatic release sheet was then laminated also onto the other surface of the release sheet at a temperature of 60° C. In this way, each sheet for sealing was produced which had a thickness of 400 μm, a length of 350 mm and a width of 350 mm.

### <Surface Specific Resistance Value Measurement>

The release sheet at the innermost layer side of one of the sheets for sealing, and that at the outermost layer side thereof were each peeled, and then about the outer surface of each of the innermost layer, and the outermost layer, and one of the surfaces of the release sheets, the surface specific resistance value was measured. The measurement of the surface specific resistance was made using a super high resistance measuring sample box TR-42 of Megohmmeter TR08601 manufactured by Advantest in the state that a DC voltage of 100 V was applied to the sample for 1 minute under conditions of a temperature of 23° C. and a relative humidity of 60%. The results are shown in Table 1.

### <Peel Electrification Voltage Measurement>

From each of the sheets for sealing, the release sheet on the surface of this sealing sheet that was opposite to one of the surfaces of the sealing sheet which were to be measured was peeled, and then the sealing sheet was bonded onto an acrylic plate (thickness: 1 mm, width: 70 mm, and length: 100 mm) destaticized beforehand. The bonding was attained to face the acrylic plate and the release sheet-removed surface of the sealing sheet to each other with a double-sided tape interposed therebetween using a hand roller.

This sample was allowed to stand still in an environment of 23° C. temperature and 50% relative humidity for one day, and then set into a predetermined position (see FIG. 12). An end of the release sheet was fixed onto an automatic winding machine, and then the release sheet was peeled at a peeling angle of 180° and a peel rate of 10 m/min. At this time, the generated potential of the release sheet-side surface of the sample was measured using a potential meter (KSD-0103, manufactured by Kasuga Electric Works Ltd.) fixed at a predetermined position. The measurement was made in an environment of 23° C. temperature and 50% relative humidity. The results are shown in Table 1.

### <Peel Strength Measurement>

From each of two of the sheets for sealing, a test specimen was cut out which was in the form of a strip of 100 mm length and 20 mm width. The release sheet on the surface of the specimen that was opposite to one of the surfaces of the sealing sheet which were to be measured was removed, and then a SUS plate was lined with the release sheet-removed surface of the specimen. Thereafter, a peeling tester (trade name: “Autograph AGS-J,” manufactured by Shimadzu Corporation) was used to peel away the other release sheet from the sheet for sealing at a temperature of 23° C., a peeling angle of 90° and a tension rate of 300 mm/min (the peeling was attained at the interface between the release sheet and the sheet for sealing). The maximum load out of the loads generated at the time of this peeling (the maximum load value other than the load of a top peak at the initial stage of the measurement) was measured. This maximum load was gained as the peel strength between the release sheet and the sheet for sealing (adhering strength of the release sheet onto the sheet for sealing) (adhering strength; N/20 mm width). The results are shown in Table 1.

TABLE 1

| | Surface specific | | Peel | | | |
|---|---|---|---|---|---|---|
| | resistance value | | electrification | | Peel strength | |
| | [Ω] | | voltage [kV] | | [N/20 mm] | |
| Example 1 | 2.0 × 10⁹ | | 0.05 | | 0.02 | |
| Example 2 | 1.0 × 10¹² | | 0.4 | | 0.02 | |
| Example 3 | Outermost | 2.0 × 10⁹ | Outermost | 0.05 | Outermost | 0.02 |
| | layer side: | | layer side: | | layer side: | |
| | Innermost | 1.0 × 10¹⁴ | Innermost | 0.5 | Innermost | 0.02 |
| | layer side: | | layer side: | | layer side: | |
| Example 4 | Outermost | 1.0 × 10¹² | Outermost | 0.4 | Outermost | 0.02 |
| | layer side: | | layer side: | | layer side: | |
| | Innermost | 1.0 × 10¹⁴ | Innermost | 0.5 | Innermost | 0.02 |
| | layer side: | | layer side: | | layer side: | |
| Example 5 | Outermost | 1.0 × 10¹⁴ | Outermost | 0.5 | Outermost | 0.02 |
| | layer side: | | layer side: | | layer side: | |
| | Innermost | 2.0 × 10⁹ | Innermost | 0.05 | Innermost | 0.02 |
| | layer side: | | layer side: | | layer side: | |
| Example 6 | Outermost | 1.0 × 10¹⁴ | Outermost | 0.5 | Outermost | 0.02 |
| | layer side: | | layer side: | | layer side: | |
| | Innermost | 1.0 × 10¹² | Innermost | 0.4 | Innermost | 0.02 |
| | layer side: | | layer side: | | layer side: | |
| Example 7 | Outermost | 1.0 × 10¹⁴ | Outermost | 0.01 | Outermost | 0.02 |
| | layer side: | | layer side: | | layer side: | |
| | Innermost | 1.0 × 10¹⁴ | Innermost | 0.01 | Innermost | 0.02 |
| | layer side: | | layer side: | | layer side: | |
| | Release | 1.0 × 10⁸ | | | | |
| | sheet | | | | | |
| | rear | | | | | |
| | surface: | | | | | |

### DESCRIPTION OF REFERENCE SIGNS

10, 40: Sheet for sealing
20, 50: Stacked body
22: Semiconductor wafer
23, 53: Semiconductor chip
28, 58: Sealed body
29, 59: Semiconductor device
60: Tentatively fixing member

1. A sheet for sealing in which a semiconductor chip is to be embedded,
a surface of the sheet having a surface specific resistance value of 1.0×10¹²Ω or less.

2. The bonding sheet according to claim 1, wherein an antistatic agent is contained in the sheet for sealing.

3. A method for manufacturing a semiconductor device, comprising:
a step A of fixing a semiconductor chip onto a support, and
a step B of embedding the semiconductor chip fixed onto the support in a sheet for sealing to form a sealed body,
wherein a surface of the sheet for sealing has a surface specific resistance value of 1.0×10¹²Ω or less.

4. The method for manufacturing a semiconductor device according to claim 3, wherein an antistatic agent is contained in the sheet for sealing.
